(19) United States
(12) Patent Application Publication
(10) Pub. No.: US 2007/0271275 A1
(43) Pub. Date: Nov. 22, 2007

(54) DATABASE MANAGEMENT FUNCTION PROVIDER SYSTEMS

(76) Inventors: Anthony M. Fassette, Peoria, AZ (US); Jason A. Young, Mesa, AZ (US); Sean Laughlin, Milford, OH (US); Jason M. Rosen, Las Vegas, NV (US)

Correspondence Address: STONEMAN LAW OFFICES, LTD, 3113 NORTH 3RD STREET, PHOENIX, AZ, 85012, US

(21) Appl. No.: 11/744,191

(22) Filed: May 3, 2007

Related U.S. Application Data
(60) Provisional application No. 60/746,630, filed on May 5, 2006.

(51) Int. Cl. G06F 17/30

(52) U.S. Cl. 707/10

(57) ABSTRACT

A system for improving management and delivery of database management functions (also know as APIs) to customers. Additionally, the system encompasses methods for simplifying delivery and use of standardized database management functions by users while improving management and control of the standardized database management functions (API's) through unique methods of encryption, decryption and execution management.

### CROSS-REFERENCE TO RELATED APPLICATION

The present application is related to and claims priority from prior provisional application Ser. No. 60/746,630, filed May 5, 2006, entitled “DATABASE MANAGEMENT FUNCTION PROVIDER SYSTEMS”, the content of which is incorporated herein by this reference and is not admitted to be prior art with respect to the present invention by the mention in this cross-reference section.

### BACKGROUND

This invention relates to providing a system for improved management and delivery of database management functions to customers. More particularly, this invention relates to providing a system for simplifying delivery and use of standardized database management functions (commonly referred to as API's) by users while improving management and control of the standardized database management functions (API's) through unique methods of encryption, decryption and execution management.

Today, many corporations use enterprise software provided by companies such as PeopleSoft, J D Edwards, Siebel and others to facilitate their daily operations, including automation of back-office and front-office operations such as finance, customer relationship management, human resources, and manufacturing. Enterprise software typically consists of client and server applications utilizing a common database. The enterprise software through its client and server applications provides access to the database while enforcing the business logic for the corporation. Typically, business logic is implemented through routines that perform the data entry, editing, validation, update, query and report processing and, more specifically, the processing that takes place behind the scenes rather than the presentation logic required to display the data on the screen (GUI processing).

As businesses evolve, it may become necessary to customize existing enterprise software applications or create new applications that interact with the database associated with the enterprise software. Because these customizations often rely on the complex business logic of the enterprise software, it typically requires a high level of expertise to develop and implement these customizations, making their implementation and maintenance time-consuming and expensive.

To assist with this problem, enterprise software vendors and third-party solution vendors may provide API toolkits to assist in development of the new or modified business logic by either in-house staff or outside consultants.

One method of implementation of these customization API's may be by installation of the related API library on every computer on which it is desired to install the client application. Additionally, these computers must be able to access the enterprise software database. The result is a maintenance headache because, as the business logic continues to evolve, the enterprise software changes and as new users are brought on line each user computer must be updated. In large corporations with many users and frequent changes, keeping each computer updated becomes an extremely complex and time-consuming process thus slowing implementation of needed changes and improvements.

Another method of implementation of these customized API's may be by installation of the related API library on a server computer from which the desired API library is executed on request from the user's computer (client computer). Typically, the server computer (host computer) receives the inputs from the client computer and controls execution of the requested API and returns the results to the user's computer. The server computer and related operations may be implemented as a web service and use a standard Internet-based communication protocol such as http. In this environment, the server computer is responsible for interaction with the enterprise software database returning the results to the user's computer. In this environment, it is only required to install the API library on the server computer that hosts the web service, which must be able to access the enterprise software database. The computers on which the client application is installed need only be able to access the server hosting the web services.

While this implementation method may reduce the maintenance headaches, they are not completely eliminated because business logic changes, upgrades to new versions of the database management system, and changes in the enterprise software require the customized API's to be updated, re-tested and re-implemented by internal corporate staff or by consultants. This is still a time-consuming and costly process which delays needed improvements that are necessary to meet changing business requirements and changes in technology.

From the perspective of third-party solution vendors and consultants, providing and updating customized API's is lucrative business, but maintaining and delivering customized API's for each version of enterprise software and each database management system combination to each customer can be expensive and unproductive. Additionally, once a customized API is delivered to a customer, the third-party solution vendor or consultant loses control of the use and replication of the customized API. While legal restrictions of licensing typically limit use of the customized API, there is no effective technologically-based method for a third-party solution vendor or consultant to retain effective control. Consequently, customized API's may be copied and modified and/or used in ways not permitted by the license, resulting in lost revenue and lost revenue opportunities for third-party solution vendors and consultants, as well as unwanted disclosure of methods they consider to be trade secrets.

Thus, a great need exists for a system, capable of effectively delivering API's to businesses, which minimizes implementation and maintenance costs to the business while improving control of delivered API's for third-party solution vendors and consultants.

### OBJECTS AND FEATURES OF THE INVENTION

A primary object and feature of the present invention is to provide a system for delivery of database management functions on request to authorized users.

It is a further object and feature of the present invention to provide such a system that reduces cost of usage of database management functions for authorized users.

It is a further object and feature of the present invention to provide such a system that reduces maintenance effort associated with updating database management functions for authorized users.

It is a further object and feature of the present invention to provide such a system that prevents unauthorized disclosure of trade secrets associated with database management functions from third-party solutions vendors and consultants.

It is a further object and feature of the present invention to provide such a system that ensures technological control of usage of database management functions from third-party solutions vendors and consultants.

It is a further object and feature of the present invention to provide such a system that prevents unauthorized disclosure of information owned by an authorized user during operation of a database management function from third-party solutions vendors and consultants.

It is a further object and feature of the present invention to provide such a system that provides a method for generating an ongoing stream of revenue associated with operation of database management functions by authorized users.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a network-based method relating to providing at least one database management function, by at least one host database-management-functions provider, to at least one client user of at least one client content database, comprising the steps of: securing, by such at least one host database-management-functions provider, of at least one program-code module structured and arranged to interact with such at least one client content database; receiving, by such at least one host database-management-functions provider, of at least one request, from such at least one client user, relating to execution of such at least one database management function relating to such at least one client content database; computer-generating, by such at least one host database-management-functions provider, of such requested at least one database management function from such at least one program-code module; transmitting, by such at least one host database-management-functions provider, such requested at least one database management function to such at least one client user; and empowering, by such at least one host database-management-functions provider, of such at least one client user, to computer-execute such at least one transmitted database management function. Moreover, it provides such a network-based method further comprising the steps of: assigning, by such at least one host database-management-functions provider, at least one unique encryption key to such at least one client user; and encrypting, by such at least one host database-management-functions provider, of such at least one computer-generated database management function, using such assigned at least one encryption key. Additionally, it provides such a network-based method wherein such step of empowering, by such at least one host database-management-functions provider, of such at least one client user, to computer-execute such at least one transmitted database management function comprises the steps of: transmitting, by such at least one host database-management-functions provider, of at least one function processor to such at least one client user; wherein such at least one function processor comprises such assigned at least one encryption key; and wherein such at least one function processor is structured and arranged to hide such assigned at least one encryption key from such at least one client user; and enabling decrypting, by such transmitted at least one function processor, of such encrypted at least one database management function, using such assigned at least one encryption key; enabling computer-executing, using such transmitted at least one function processor, of such decrypted at least one database management function on behalf of such at least one client user; and enabling presenting of at least one result of such computer-execution of such transmitted database management function to such at least one client user. Also, it provides such a network-based method further comprising the steps of: receiving, by such at least one host database-management-functions provider, of client data relating to such requested database management function and relating to such at least one client content database, from such at least one client user; and computer-generating, by such at least one host database-management-functions provider, of at least one database management function; wherein such computer-generated at least one database management function comprises such received client data; and wherein such computer-generated at least one database management function comprises such requested at least one database management program-code module. In addition, it provides such a network-based method further comprising the steps of: offering, by such at least one host database-management-functions provider, authorization to request computer execution of such at least one database management function, to such at least one client user; receiving, by such at least one host database-management-functions provider, at least one minimum payment for at least one predicted number of such requests for such computer executions on behalf of such at least one client user; and performing such authorizing by such at least one host database-management-functions provider. And, it provides such a network-based method further comprising the steps of: offering, by such at least one host database-management-functions provider, authorization to request computer execution of such at least one database management function, to such at least one client user; receiving, by such at least one host database-management-functions provider, at least one minimum payment for at least one predicted number of such requests for such computer executions on behalf of such at least one client user; and performing such authorizing by such at least one host database-management-functions provider. Further, it provides such a network-based method further comprising the steps of: estimating, by such at least one client user, of at least one first count of requests for computer-execution of such at least one database management function for at least one time period; associating, by such at least one host database-management-functions provider, of at least one monetary value with computer-execution of such at least one database management function; calculating, by such at least one host database-management-functions provider, of such at least one minimum payment comprising at least one amount from multiplying of such at least one first count multiplied by such monetary value; accumulating, by such at least one host database-management-functions provider, at least one second count of actual requests for computer-execution of such at least one database management function for such at least one time period; calculating, by such at least one host database-management-functions provider, cost of computer-execution of such at least one database management function by multiplying such at least one second count by such monetary value; receiving, by such at least one host database-management-functions provider, at least one overage payment from such at least one client user when such cost exceeds such at least one amount from multiplying of such at least one first count multiplied by such monetary value for such at least one time period. Even further, it provides such a network-based method further comprising the step of licensing, by such at least one host database-management-functions provider, operations of such database-management-functions provider to at least one licensee. Moreover, it provides such a network-based method further comprising the step of permitting, by such at least one host database-management-functions provider, providing at least one database command by such at least one client user to be included for determined sequential computer-execution within such computer-generated at least one database management function. Additionally, it provides such a network-based method wherein such step of computer-generating, by such at least one host database-management-functions provider, of such requested at least one database management function from such at least one program-code module is completed within at least one host network, controlled by such at least one host database-management-functions provider. Also, it provides such a network-based method wherein such step of computer-executing, using such transmitted at least one function processor, such decrypted at least one database management function on behalf of such at least one client user is completed within at least one client network, controlled by such at least one client user. In addition, it provides such a network-based method further comprising the steps of: providing, by such at least one host database-management-functions provider at least one inter-network communications manager tool to such at least one client user; and managing, by such at least one inter-network communications manager tool, inter-network communications between such at least one client network and such at least one host network on behalf of such at least one client user; wherein such inter-network communications relate to such step of computer-generating, by such at least one host database-management-functions provider, of such requested at least one database management function from such at least one program-code module; and wherein such inter-network communications relate to such step of computer-executing, using such transmitted at least one function processor, such decrypted at least one database management function on behalf of such at least one client user. And, it provides such a network-based method further comprising the step of storing such at least one function processor within such at least client content database as at least one stored procedure. Further, it provides such a network-based method further comprising the steps of: associating, by such at least one host database-management-functions provider, at least one date of expiration with such computer-generated at least one database management function; and preventing, by such at least one host database-management-functions provider, computer-execution of such at least one database management function when current date is greater than such associated at least one expiration date.

In accordance with another preferred embodiment hereof, this invention provides a network-based computer program system, relating to providing at least one database management function, to at least one client user of at least one client content database, comprising: at least one first computer interface for inputting at least one program-code module structured and arranged to interact with such at least one client content database; at least one first computer database storage for storing of such at least one program-code module in at least one host program-code module database; at least one second computer interface structured and arranged to receive at least one request, by such at least one client user, relating to execution of such at least one database management function relating to such at least one client content database; at least one first computer processor structured and arranged to generate such requested at least one database management function from such stored at least one program-code module; at least one first computer transmitter for transmitting such requested at least one database management function to such at least one client user; and at least one second computer processor structured and arranged to control execution of such at least one transmitted database management function against such at least one client content database. Even further, it provides such a network-based computer program system, further comprising: at least one third computer processor structured and arranged to assign at least one unique encryption key to such at least one client user; and at least one fourth computer processor structured and arranged to encrypt such at least one computer-generated database management function, using such assigned at least one encryption key. Moreover, it provides such a network-based computer program system, further comprising: at least one fifth computer processor structured and arranged to generate such at least one second computer program; wherein such generated at least one second computer program comprises such assigned at least one encryption key; and wherein such generated at least one second computer program is structured and arranged to hide such assigned at least one encryption key from such at least one client user; and at least one second computer transmitter structured and arranged to transmit such generated at least one second computer program to such at least one client user; wherein such generated at least one second computer processor is further structured and arranged to decrypt such encrypted at least one database management function, using such assigned at least one encryption key; wherein such generated at least one second computer processor is further structured and arranged to execute such decrypted at least one database management function against such at least one client content database on behalf of such at least one client user; and at least one third computer interface structured and arranged to display at least one result of such computer-execution of such generated database management function to such at least one client user. Additionally, it provides such a network-based computer program system, further comprising: at least one fourth computer interface structured and arranged to receive client data relating to such requested database management function and relating to such at least one client content database, from such at least one client user; wherein such at least one first computer processor is further structured and arranged to generate at least one database management function from such received client data and such requested at least one database management program-code module. Also, it provides such a network-based computer program system, further: at least one fifth computer interface structured and arranged to offer authorization to request computer execution of such at least one database management function, to such at least one client user; at least one sixth computer interface structured and arranged to record at least one minimum payment amount on behalf of such at least one client user; and at least one second computer database storage structured and arranged to store such recorded at least one minimum payment in at least one payments database; at least one sixth computer processor structured and arranged to authorize requesting computer-execution of such at least one database management function by such at least one client user. In addition, it provides such a network-based computer program system, further comprising: at least one seventh computer interface structured and arranged to record at least one estimated count of requests for computer-execution of such at least one database management function, for at least one time period, on behalf of such at least one client user; at least one eighth computer interface structured and arranged to receive at least one monetary value related to execution of such at least one database management function; at least one third computer database storage structured and arranged to store such received at least one monetary value related to execution of such at least one database management function in at least one monetary value database; at least one seventh computer processor structured and arranged to calculate such at least one minimum payment comprising at least one amount from multiplying of such at least one estimated count multiplied by such monetary value; at least one eighth computer processor structured and arranged to accumulate at least one actual count of actual requests for execution of such at least one database management function for such at least one time period; at least one ninth computer processor structured and arranged to calculate cost of execution of such at least one database management function by multiplying such at least one actual count by such monetary value; at least one tenth computer processor structured and arranged to notify such at least one client user such calculated cost of execution exceeds such at least one minimum payment for such at least one time period; and at least one tenth computer interface structured and arranged to record at least one overage payment from such at least one client user. And, it provides such a network-based computer program system, further comprising: at least one eleventh computer interface structured and arranged to permit inputting of at least one database command to be included for determined sequential computer-execution within such generated at least one database management function, on behalf of such at least one client user; and at least one first computer processor further structured and arranged to consolidate such at least one database command with such generated at least one database management function. Further, it provides such a network-based computer program system, wherein such at least one first computer processor operates within at least one host network. Even further, it provides such a network-based computer program system, wherein such at least one second computer processor operates within at least one client network. Moreover, it provides such a network-based computer program system, further comprises: at least one twelfth computer processor structured and arranged to manage inter-network communication between such at least one client network and such at least one host network on behalf of such at least one client user; wherein such inter-network communications relate to such at least one first computer processor; and wherein such inter-network communications relate to such at least one second computer processor. Additionally, it provides such a network-based computer program system, comprises: at least one fourth computer storage structured and arranged to store, as at least one stored procedure, such at least one second computer processor within such at least one client content database. Also, it provides such a network-based computer program system, further comprises: such at least one first computer processor further structured and arranged to generate such requested at least one database management function with at least one date of expiration; and such at least one second computer process further structured and arranged to preventing execution of such requested at least one database management function when current date is greater than such at least one expiration date of such requested at least one database management function.

In accordance with another preferred embodiment hereof, this invention provides a network-based computer program system, relating to providing at least one database management function to at least one client user, comprising the steps of: permitting inputting at least one program-code module structured and arranged to interact with such at least one client content database; storing of such at least one program-code module structured and arranged to interact in at least one host program-code module database; permitting inputting of at least one request, on behalf of such at least one client user, relating to execution of such at least one database management function relating to such at least one client content database; executing at least one function generator to generate such requested at least one database management function from such stored at least one program-code module; transmitting such requested at least one database management function to such at least one client user; and controlling, on behalf of such at least one client user, execution of such at least one transmitted database management function against such at least one client content database. In addition, it provides such a network-based computer program system further comprising the steps of: assigning at least one unique encryption key to such at least one client user; and encrypting such at least one generated database management function, using such assigned at least one encryption key. And, it provides such a network-based computer program system wherein such step of controlling, on behalf of such at least one client user, execution of such at least one transmitted database management function against such at least one client content database comprises the steps of: generating at least one function processor on behalf of such at least one client user; wherein such generated at least one function processor comprises such assigned at least one encryption key; wherein such generated at least one function processor is structured and arranged to hide such assigned at least one encryption key from such at least one client user; and transmitting, such at least one function processor to such at least one client user; executing such generated at least one function processor to decrypt such encrypted at least one database management function, using such assigned at least one encryption key; executing such at least one function processor to complete execution of such decrypted at least one database management function on behalf of such at least one client user; and displaying at least one result of such computer-execution of such transmitted database management function to such at least one client user. Further, it provides such a network-based computer program system further comprising the steps of: permitting inputting of client data relating to such requested database management function and relating to such at least one client content database, by such at least one client user; and executing such at least one function generator to generate at least one database management function; wherein such generated at least one database management function comprises such inputted client data; and wherein such generated at least one database management function comprises such at least one database management program-code module. Even further, it provides such a network-based computer program system further comprising the steps of: permitting inputting of recording at least one minimum payment amount for authorization to request execution of such at least one database management function on behalf of such at least one client user; storing such inputted at least one minimum payment amount in at least one client payments database; and authorizing requesting execution of such at least one database management function by such at least one client user. Even further, it provides such a network-based computer program system wherein such step of permitting inputting of at least one minimum payment amount for authorization to request execution of such at least one database management function on behalf of such at least one client user comprises the steps of: permitting inputting, on behalf of such at least one client user of at least one estimated count of requests for execution of such at least one database management function for at least one time period; permitting inputting at least one monetary value associated with execution of such at least one database management function; storing such inputted at least one monetary value in at least one monetary values database; calculating such at least one minimum payment comprising at least one amount from multiplying such at least one estimated count by such at least one monetary value; accumulating at least one actual count of inputted requests for computer-execution of such at least one database management function for such at least one time period; calculating at least one cost of executing such at least one database management function by multiplying such at least one actual count by such monetary value for such at least one database management function; notifying such at least one client user of at least one overage payment amount due when such calculated at least one cost exceeds such received at least one minimum payment amount; permitting inputting of receipt of such at least one overage payment amount; and storing such received at least one overage payment amount in such at least one client payments database. Even further, it provides such a network-based computer program system further comprising the steps of; permitting inputting, by such at least one client user, of at least one database command to be included for determined sequential execution within such generated at least one database management function; and executing such at least one function processor to execute such at least one database command in such determined sequential execution with such generated at least one database management function. Even further, it provides such a network-based computer program system wherein such step of executing at least one function generator to generate such requested at least one database management function from such stored at least one program-code module is completed within at least one host network controlled by such at least one network-based computer program system operator. Even further, it provides such a network-based computer program system wherein such step of executing such at least one function processor to complete execution of such decrypted at least one database management function on behalf of such at least one client user is completed within at least one client network controlled by such at least one client user. Even further, it provides such a network-based computer program system further comprising the steps of: executing at least one inter-network communications manager to manage inter-network communications between such at least one client network and such at least one host network on behalf of such at least one client user; and wherein such inter-network communications relate to execution of such at least one function processor; wherein such inter-network communications relate to execution of such at least one function generator. Even further, it provides such a network-based computer program system further comprising the step of storing such at least one function processor within such at least client content database as at least one stored procedure. Even further, it provides such a network-based computer program system further comprising the steps of: executing such at least one function generator to generate such at least one database management function with at least one date of expiration; and executing such at least one function generator to prevent execution of such at least one database management function when current date is greater than such associated at least one expiration date.

### BRIEF DESCRIPTION OF THE DRAWINGS

FIG. 1 shows an overview schematic diagram of the primary functional components and preferred communication method of Database Management Function Provider Systems, according to a preferred embodiment of the present invention.

FIG. 2 shows an overview schematic diagram of an example communication architecture that may be used to implement Database Management Function Provider Systems, according to a preferred embodiment of the present invention.

FIG. 3 shows overview schematic diagrams of example communication protocols that may be used in conjunction with operation of Database Management Function Provider Systems, according to a preferred embodiment of the present invention.

FIG. 4 shows an overview schematic diagram of the operation of Database Management Function Provider Systems, according to a preferred embodiment of the present invention.

FIG. 5 shows a schematic diagram of data flow and component operation of API Generator sub-process of Database Management Function Provider Systems, according to a preferred embodiment of the present invention.

FIG. 6 shows the logic sequence used by API Generator sub-process of Database Management Function Provider Systems, according to a preferred embodiment of the present invention.

FIG. 7 shows a schematic diagram of data flow and component operation of API Processor sub-process of Database Management Function Provider Systems, according to a preferred embodiment of the present invention.

FIG. 8 shows the logic sequence used by API Processor sub-process of Database Management Function Provider Systems, according to a preferred embodiment of the present invention.

FIG. 9 shows a schematic diagram of Subscription Business Method associated with Database Management Function Provider Systems, according to a preferred embodiment of the present invention.

FIG. 10 shows a schematic diagram of Subscription Licensing Process for use of Database Management Function Provider Systems, according to a preferred embodiment of the present invention.

FIG. 11 shows a schematic diagram of an Application Developer Licensing Business Method associated with Database Management Function Provider Systems, according to a preferred embodiment of the present invention.

FIG. 12 shows a schematic diagram of Operations Licensing Business Method associated with Database Management Function Provider Systems, according to a preferred embodiment of the present invention.

FIG. 13 shows a schematic diagram of use of Request/Response Broker Process to manage communications between client network and host network for Database Management Function Provider Systems when access outside of client network is restricted, according to a preferred embodiment of the present invention.

FIG. 14 shows a sample XML request used within Database Management Function Provider Systems, according to a preferred embodiment of the present invention.

FIG. 15 shows a sample API template used within Database Management Function Provider Systems, according to a preferred embodiment of the present invention.

FIG. 16 shows a sample transformed API template with client data as used within Database Management Function Provider Systems, according to a preferred embodiment of the present invention.

FIG. 17 shows a sample transformed API template with client data after encryption as used within Database Management Function Provider Systems, according to a preferred embodiment of the present invention.

FIG. 18 shows a sample XML response with encrypted transformed API template with client data as used within Database Management Function Provider Systems, according to a preferred embodiment of the present invention.

FIG. 19 shows a sample Function Processor execution with optionally pre- and post-pended SQL as used within Database Management Function Provider Systems, according to a preferred embodiment of the present invention.

FIG. 20 shows sample output from Function Processor as used within Database Management Function Provider Systems, according to a preferred embodiment of the present invention.

FIG. 21 shows sample output with optionally pre- and post-pended SQL execution results from Function Processor as used within Database Management Function Provider Systems, according to a preferred embodiment of the present invention.

FIG. 22 shows sample output from a database profiler associated execution of sample transformed and encrypted API template with pre- and post-pended SQL by Function Processor, according to a preferred embodiment of the present invention.

FIG. 23 shows a sample user screen for selecting an API template for execution within Database Management Function Provider Systems, according to a preferred embodiment of the present invention.

FIG. 24 shows a sample user screen for installing Function (Response) Processor associated with Database Management Function Provider Systems, according to a preferred embodiment of the present invention.

FIG. 25 shows a sample user screen confirming creation of an appropriate Function (Response) Processor associated with Database Management Function Provider Systems, according to a preferred embodiment of the present invention.

FIG. 26 shows a sample confirmation email with attached Function (Response) Processor received by an authorized user, according to a preferred embodiment of the present invention.

FIG. 27 shows a sample user screen for inputting client data and license key, and requesting execution of the desired API template associated with Database Management Function Provider Systems, according to a preferred embodiment of the present invention.

FIG. 28 shows a sample user screen displaying results of execution of the requested API template with client data by API (Response) Processor associated with Database Management Function Provider Systems, according to a preferred embodiment of the present invention.

FIG. 29 shows an example set of user instructions for the installation Response Processor (API Processor) for SQL Server 2005 which is required for execution of a requested API template associated with Database Management Function Provider Systems, according to a preferred embodiment of the present invention.

### DEFINITIONS, ACRONYMS AND CROSS-REFERENCES

The following terms and acronyms are explained below as background and are used throughout the detailed description:

Application Program Interface (API). A set of routines, protocols, and tools for building software applications. A good API makes it easier to develop a program by providing all the building blocks. A programmer puts the blocks together. Most operating environments, such as MS-Windows, provide an API so that programmers can write applications consistent with the operating environment. Although APIs are designed for programmers, they are ultimately good for users because they guarantee that all programs using a common API will have similar interfaces. This makes it easier for users to learn new programs. An application programming interface (API) is the interface that a computer system, library or application provides in order to allow requests for service to be made of it by other computer programs, and/or to allow data to be exchanged between them. One of the primary purposes of an API is to describe how to access a set of functions—for example, an API might describe how to draw windows or icons on the screen using a library that has been written for that purpose. API's, like most interfaces, are abstract. Software that may be accessed via a particular API is said to implement that API. (API's are also referred to as database management functions within this specification).

Cascading Style Sheet (CSS). Cascading Style Sheet (CSS) is a style sheet language used to describe the presentation of a document written in a markup language. Its most common application is to style web pages written in HTML and XHTML. The CSS specifications are maintained by the World Wide Web Consortium (W3C). CSS is used by both the authors and readers of web pages to define colors, fonts, layout, and other aspects of document presentation. It is designed primarily to enable the separation of document content (written in HTML or a similar markup language) from document presentation (written in CSS). Multiple style sheets can be imported, and alternative style sheets can be specified so that the user can choose between them. Different styles can be applied depending on the output device being used. For example, the screen version may be quite different from the printed version. This allows authors to tailor the presentation appropriately for each kind of media.

Client-Server. A model of interaction in a distributed system in which a program at one site sends a request to a program at another site and waits for a response. The requesting program is called the “client,” and the program that responds to the request is called the “server” (or “host”). In the context of the Internet (World Wide Web), the client is typically a “Web browser” that runs on a user's computer; the program that responds to Web browser requests at a Web site is commonly referred to as a “Web server.”

Database. One or more large structured sets of persistent data maintained upon a computer system organized and structured according to a software system defining rules for organization as well responding to queries to read, write or modify data as well as provide statistical information regarding the contained data. As used herein for purposes of discussion, a database may be either a single unified system or a distributed system wherein certain database elements are located upon different systems, acting in harmony to appear as one unified database.

Domain Name. The “www.domain.com” portion of the URL is called a “domain name.” The domain name is a unique Internet alphanumeric address that identifies the virtual location of Internet resources related to a particular organization. For example, URLs containing the domain name “www.realtorXYZ.com” might include resources related to a company fictionally named Realtor XYZ.

Domain Name System (DNS). An Internet service that translates domain names (which are alphabetic identifiers) into IP addresses (which are numeric identifiers for machines on a TCP/IP network).

Encryption. Translation of data into a secret code. Encryption is the most effective way to achieve data security. To read an encrypted file, you must have access to a secret key or password that enables you to decrypt it. Unencrypted data is called plain text; encrypted data is referred to as cipher text. One encryption algorithm is Advanced Encryption Standard (AES), also known as Rijndael or AES/Rijndael, which is a block cipher adopted as an encryption standard by the US government. AES was adopted by National Institute of Standards and Technology (NIST) as US FIPS PUB 197 in November 2001. Other encryption algorithms include 3DES, (a block cipher formed from the Data Encryption Standard (DES) cipher by using it three times) and RSA (an algorithm for public-key encryption widely used in electronic commerce protocols).

Extensible Markup Language (XML). XML describes a class of data objects known as XML documents and partially describes the behavior of computer programs which process these documents. More specifically, XML is a restricted form of the Standard Generalized Markup Language (also known as SGML). XML documents are made up of storage units defined as entities which in turn comprise either parsed or unparsed data in the form of characters or simply a character. XML is designed and intended to improve the functionality of the Internet by providing more flexible and adaptive forms of information. XML can be used to store any kind of structured information and in such encapsulated form, pass it between different computer systems which would otherwise be unable to communicate.

Extensible Style sheet Language (XSL). A specification for separating style from content when creating HTML or XML pages. The specifications work much like templates, allowing designers to apply single style documents to multiple pages. XSL is the second style specification to be offered by the World Wide Web Consortium (W3C)(www.w3c.org). The first, called Cascading Style Sheets (CSS), is similar to XSL, but does not include two major XSL innovations—allowing developers to dictate the way Web pages are printed, and specifications allowing one to transfer XML documents across different applications. W3C released the first draft of XSL in August 1998, and promotes the specifications as helpful to the Web's speed, accessibility, and maintenance.

Extensible Style sheet Language Transformations (XSLT). An XML-based language used for the transformation of XML documents. The original document is not changed; rather, a new document is created based on the content of an existing document. The new document may be serialized (output) by the processor in standard XML syntax or in another format, such as HTML or plain text. XSLT is most often used to convert data between different XML schemas or to convert XML data into web pages or PDF documents. XSLT was produced as a result of the Extensible Stylesheet Language (XSL) development effort within W3C during 1998-1999.

File Transport Protocol (FTP). The protocol used on the Internet for exchanging files. FTP is most commonly used to download a file from a server using the Internet or to upload a file to a server (e.g., uploading a Web page file to a server).

Hypertext Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other websites and other Web documents (commonly referred to as “hyperlinks”). For more information on HTML, see Ian S. Graham, The HTML Source Book, John Wiley and Sons, Inc., 1995 (ISBN 0471 11894 4).

Hypertext Transport Protocol (HTTP). The standard Internet (World Wide Web) client server protocol used for the exchange of information (such as HTML documents and client requests for such documents) between a Web browser (client) and a Web server (host). HTTP includes a number of different types of messages that can be sent from the client to the server to request different types of server actions. For example, a “GET” message, which has the format GET, causes the server to return the document or file located at the specified Universal Resource Locator (URL).

HTTPS. HTTP over SSL (Secure Sockets Layer) can be best understood as a secure form of HTTP communication. Specifically, SSL is a protocol utilized for the authentication and encryption of HTTP traffic. In operation, the server and client exchange a set of encryption keys that are used to create a unique encryption key used to encrypt all data exchanged during the session.

Internet. A collection of interconnected (public and/or private) networks that are linked together by a set of standard protocols to form a distributed network. While this term is intended to refer to what is now commonly known as the Internet, it is also intended to encompass variations that may be made in the future, including changes and additions to existing standard protocols.

LAN. A Local Area Network of computer systems, typically within a building or office, permitting networking, the associated sharing of resources and files, such as application software, printers and client information, in an inter-office setting.

Microsoft IIS (Internet Information Services) Server. A set of Internet-based services for servers using Microsoft Windows.

Microsoft.net Framework. Commonly known as simply the NET Framework, is a software development platform created by Microsoft. .NET Framework is a Microsoft technology that allows cross-language development and provides a large standard library. Other competing approaches are cross-platform languages, i.e. Perl, using a cross-platform runtime like the Java Virtual Machine, or compile standard ANSI C to each platform.

PHP. (The initials come from the earliest version of the program, which was called “Personal Home Page Tools”) A server-side, cross-platform, HTML-embedded scripting language used to create dynamic web pages. PHP is Open Source software.

Session ID. In the case of transport protocols which do not implement a formal session layer sessions are maintained by a higher level program using a method defined in the data being exchanged. For example, an HTTP exchange between a browser and a remote host may include an HTTP cookie which identifies state, such as a unique session ID, information about the user's preferences or authorization level.

Structured Query Language (SQL). SQL is a standard language used to communicate with relational database management systems (such as Oracle, Sybase, Microsoft SQL Server, Access, etc.) for the purpose of performing tasks such as data insertion, deletion, update, and general query for the return of data.

Simple Object Access Protocol (SOAP). SOAP is a lightweight XML/HTTP-based protocol for the exchange of information in a decentralized distributed platform-independent environment. Fundamentally, SOAP consists of three parts. The first is an envelope that defines a framework for describing what is contained in the message and how it should be processed. The second is a set of encoding rules for expressing instances of application defined data types. The third is a normalized convention for representing remote procedure calls and responses.

Stored Procedure. A stored procedure is a program (or procedure) which is physically stored within a database. The exact implementation of a stored procedure varies from one database to another. In most cases however, stored procedures allow for an API to be defined for a database, rather than having a client application interact with the tables and other database objects directly. Stored procedures are supported by most major database vendors in some form, but there is debate among developers about the advantages of using stored procedures. Some people use them frequently, while others prefer to avoid using them altogether. Typical uses for stored procedures include data validation, integrated into the database structure. Stored procedures used for this purpose are often called triggers. Another common use is the encapsulation of an API for some large or complex processing that might require the execution of several SQL queries, such as manipulating a large dataset to produce a summarized result.

Transmission Control Protocol/Internet Protocol (TCP/IP). A standard Internet protocol (or set of protocols) which specifies how two computers exchange data over the Internet. TCP/IP handles issues such as packetization, packet addressing, and handshaking and error correction. For more information on TCP/IP, see Volumes I, II and III of Corner and Stevens, Internetworking with TCP/IP, Prentice Hall, Inc., ISBNs 0 13 468505 9 (vol. I), 0 13 125527 4 (vol. II), and 0 13 474222 2 (vol. III).

Uniform Resource Locator (URL). A unique address which fully specifies the location of a file or other resource on the Internet. The general format of a URL is protocol://machine address:port/path/filename. The port specification is optional, and, if not entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

WAN. A Wide Area Network, such as the Internet.

World Wide Web (“Web”). Used herein to refer generally to both (1) a distributed collection of interlinked, user viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the Hypertext Transfer Protocol (HTTP), and the electronic pages are encoded using the Hypertext Markup Language (HTML). However, the terms “World Wide Web” and “Web” are intended to encompass future markup languages and transport protocols that may be used in place of or in addition to the Hypertext Markup Language (HTML) and the Hypertext Transfer Protocol (HTTP).

Web Services Description Language (WSDL). An XML format published for describing Web services. Version V 1.1 has not been endorsed by the World Wide Web Consortium (W3C), however it has released a draft for version 2.0 on May 11, 2005, that will be a W3C recommendation, and thus endorsed by the W3C. WSDL describes the public interface to the web service. This is an XML-based service description on how to communicate using the web service; namely, the protocol bindings and message formats required to interact with the web services listed in its directory. The supported operations and messages are described abstractly, and then bound to a concrete network protocol and message format. WSDL is often used in combination with SOAP and XML Schema to provide web services over the Internet. A client program connecting to a web service can read the WSDL to determine what functions are available on the server. Any special data types used are embedded in the WSDL file in the form of XML Schema. The client can then use SOAP to actually call one of the functions listed in the WSDL.

### DETAILED DESCRIPTION OF THE BEST MODES AND PREFERRED EMBODIMENTS OF THE INVENTION

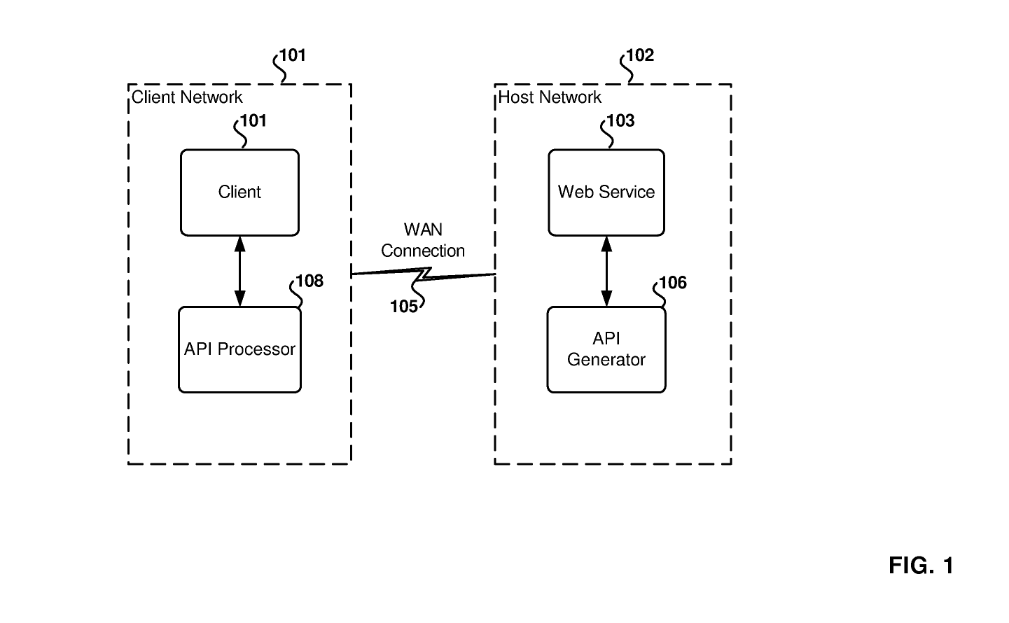

Referring to FIG. 1, which shows an overview schematic diagram of the primary functional components and preferred communication methods of Database Management Function Provider Systems 100 according to a preferred embodiment of the present invention, two primary components are preferably provided. Preferably, API Generator 106 resides within Host Network 102 communicating with and through Web Service 103 to fulfill requests for Plug-in API 207 or Standalone API 208 which are provided to API Processor 108, preferably residing within Client Network 101, which then manages execution of Plug-in API 207 or Standalone API 208 and returns the results of execution to User 110 or User 111, as appropriate. Preferably, this arrangement permits separation of the tasks of creating an executable API (also referred to herein as database management function) from the task of executing an API against Application Content Database 219 of Organization 901. Accordingly, ownership of each task and related content can be managed by separate entities.

Preferably, Client Network 101 and Host Network 102 are independent of each other but are preferably connected by WAN Connection 105. Preferably, WAN Connection 105 may be any one of several methods of digital communication including the Internet using one or more protocols including HTTP, SOAP, XML, etc.

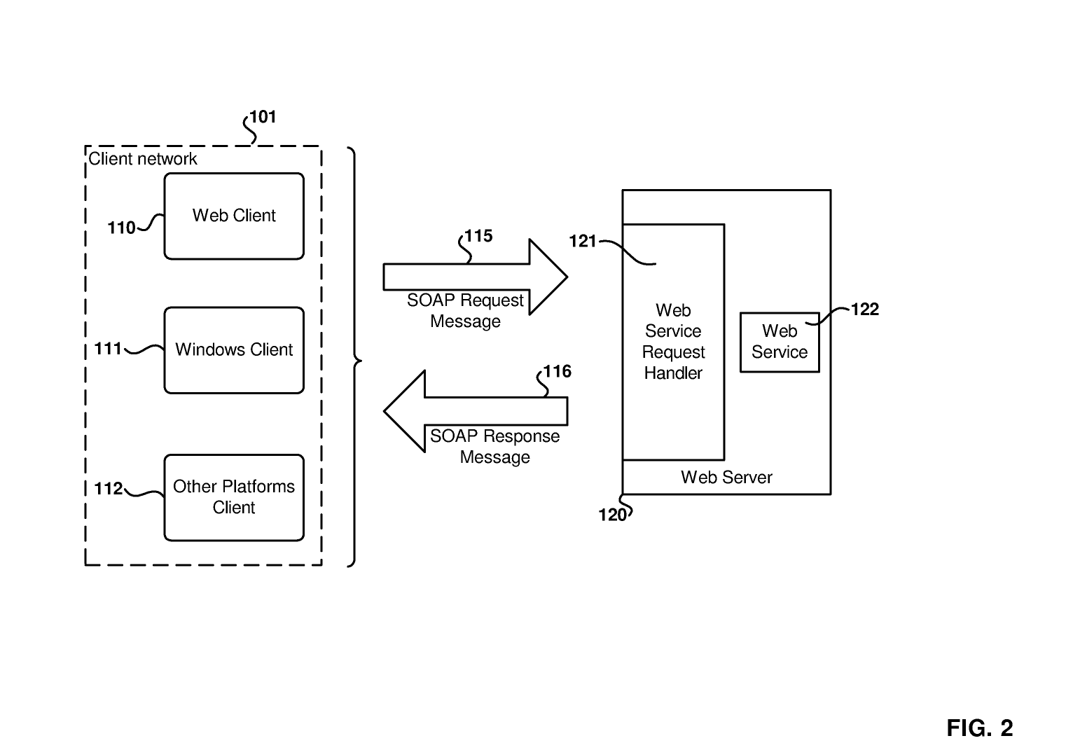

Referring to FIG. 2, which shows an overview schematic diagram of an example communication architecture that may be used to implement Database Management Function Provider Systems 100, according to a preferred embodiment of the present invention, Web Client 110, Windows Client 111 or Other Platforms Client 112 preferably may invoke Web Service 122 by first processing a WSDL document that describes the desired Web Service 122. Web Client 110, Windows Client 111 or Other Platforms Client 112 then preferably formulates a SOAP Request Message 115 based on the WSDL document and transmits it to Web Server 120 as part of an HTTP POST request. The Web Service 122 preferably operates in conjunction with Web Server 120, for example Microsoft's Internet Information Server (IIS), which receives SOAP Request Message 115 as part of the HTTP POST request. Web Server 120 preferably forwards these requests to a Web Service Request Handler 121 for processing. Web Service Request Handler 121 preferably parses SOAP Request Message 115, preferably invokes requested Web Service 122, and preferably creates the proper SOAP Response Message 116 from the results of execution of requested Web Service 122. Web server 120 preferably sends SOAP Response Message 116 back to Web Client 110, Windows Client 111 or Other Platforms Client 112, as appropriate, as part of the HTTP response. Preferably, Database Management Function Provider Systems 100 operates within the example communication architecture described above. Upon reading the teachings of this specification, those with ordinary skill in the art will now understand that, under appropriate circumstances, considering issues such as changes in technology, customer requirements, etc., other communication architectures, such as, for example, local area network architectures, wide area network architectures yet to be developed, etc., may suffice.

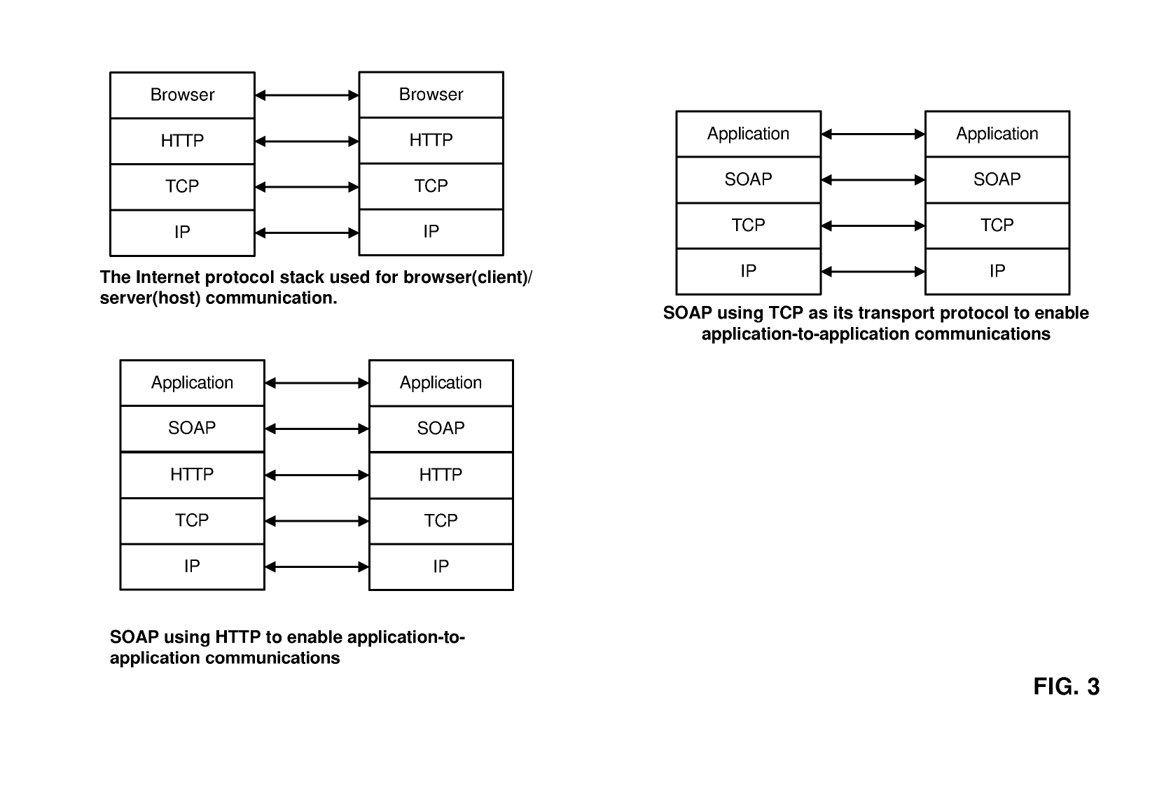

Referring to FIG. 3, overview schematic diagrams of example communication protocols that may be used in conjunction with operation of Database Management Function Provider Systems 100, according to the preferred embodiment of the present invention, are shown. Simple Object Access Protocol (SOAP) provides a standard protocol that any application can use to communicate and exchange data with any other application. To achieve platform independence and maximum operability, SOAP preferably uses XML to represent messages exchanged between Web Client 110, Windows Client 111 or Other Platforms Client 112 and Web Service 122. SOAP enables application-to-application communication over any transport protocol, including TCP. When using TCP as its transport protocol, SOAP can preferably leverage the current Internet infrastructure. SOAP can preferably also be layered over HTTP, which makes it easy to communicate over any wide area network, including the public Internet, which permits HTTP traffic.

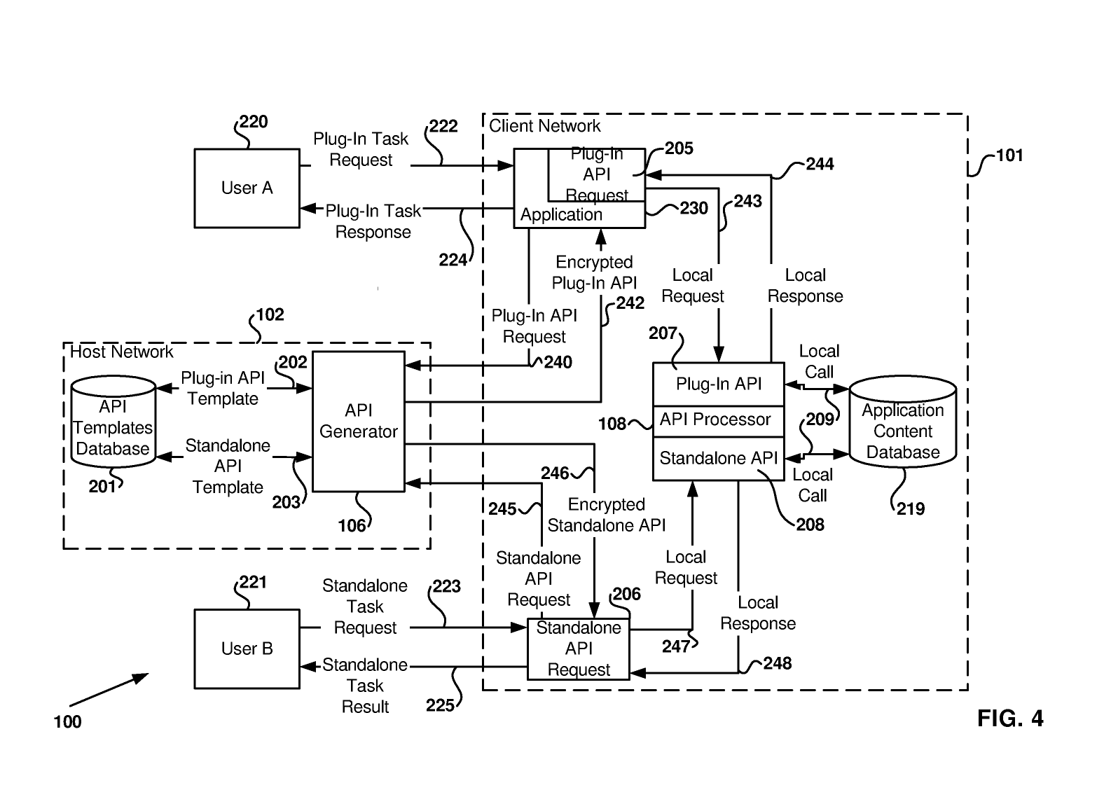

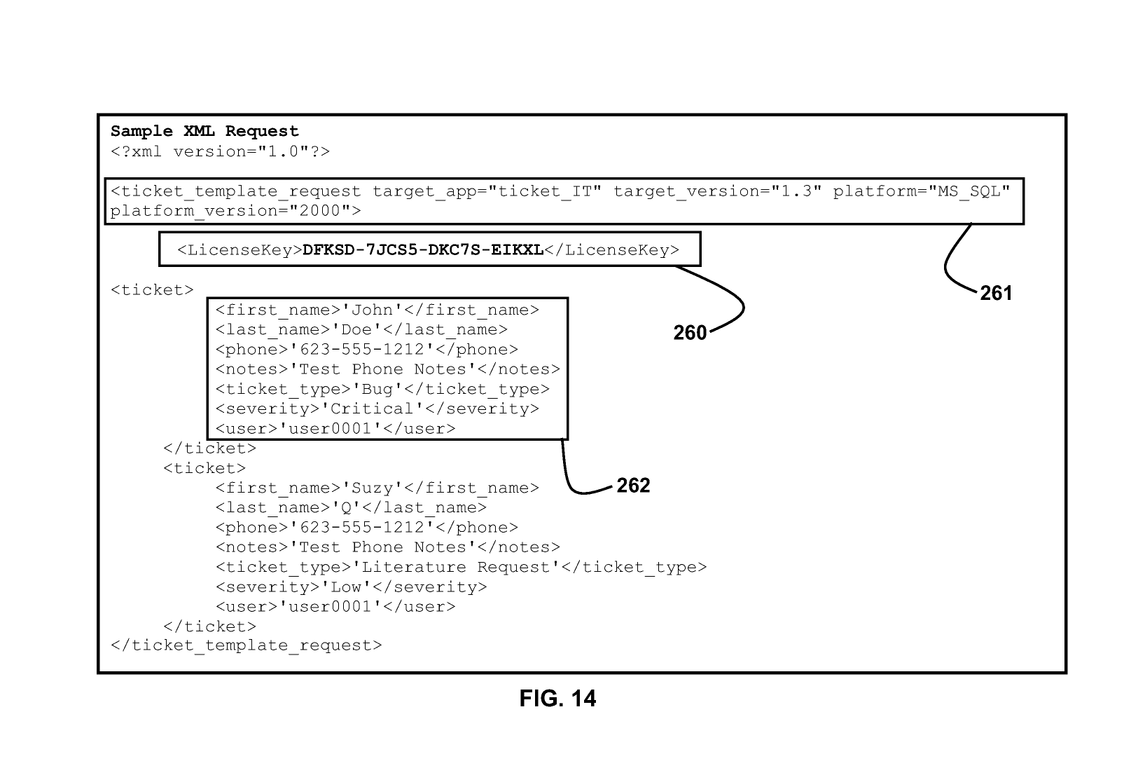

Referring to FIG. 4, which shows an overview schematic diagram of the operation of Database Management Function Provider Systems 100, according to a preferred embodiment of the present invention, preferably User A 220, using Web Client 110, Windows Client 111 or Other Platforms Client 112 operating with Client Network 101, preferably creates Task Request 222 (including any necessary data) for Plug-In API 207 which is intended to operate within Application 220 and against Application Content Database 219. Similarly, preferably User B 221, using Web Client 110, Windows Client 111 or Other Platforms Client 112 operating within Client Network 101, preferably creates Task Request 223 (including any necessary data) for Standalone API 208 which is intended to operate independently of Application 220, but against Application Content Database 219. Preferably, in both cases, the method of creating Plug-In Task Request 222 and Standalone Task Request 223 is accomplished in the manner described with respect to FIG. 2, resulting in Plug-In API Request 240 and Standalone API Request 245. An example of the XML structure of Plug-In API Request 240 and Standalone API Request 245 is shown in FIG. 14 (at least herein embodying receiving, by such at least one host database-management-functions provider, of at least one request, from such at least one client user, relating to execution of such at least one database management function relating to such at least one client content database).

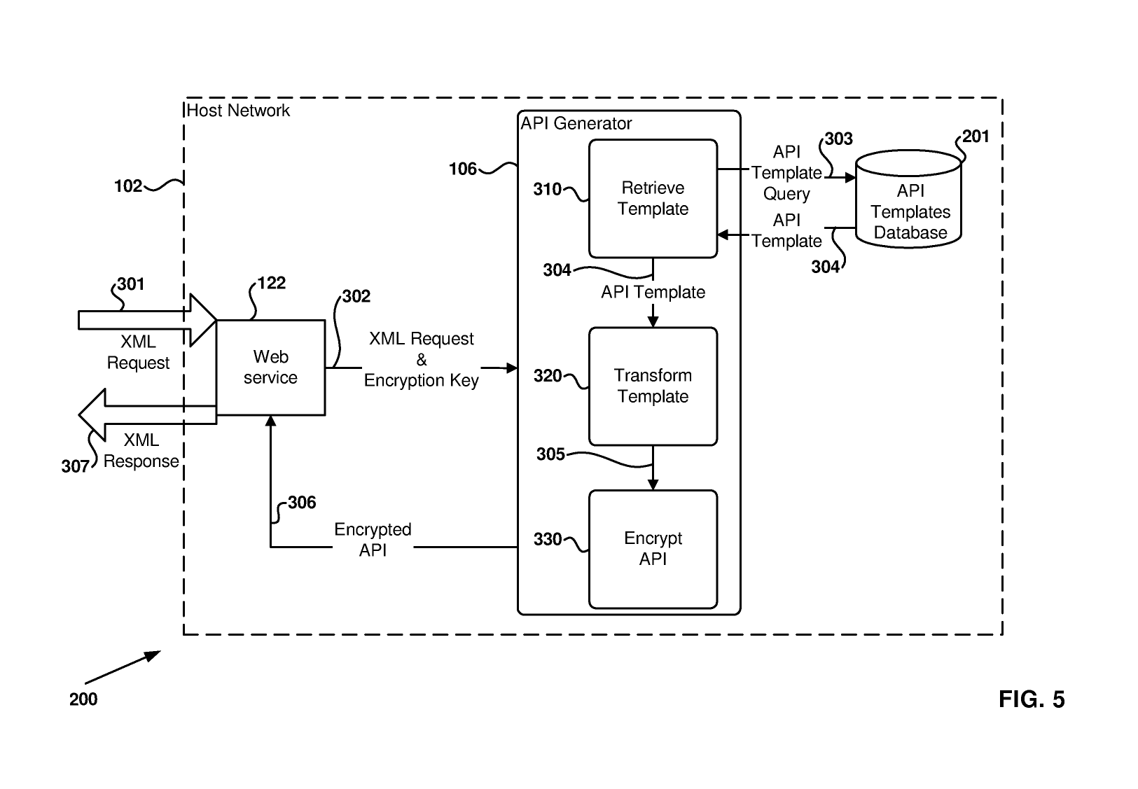

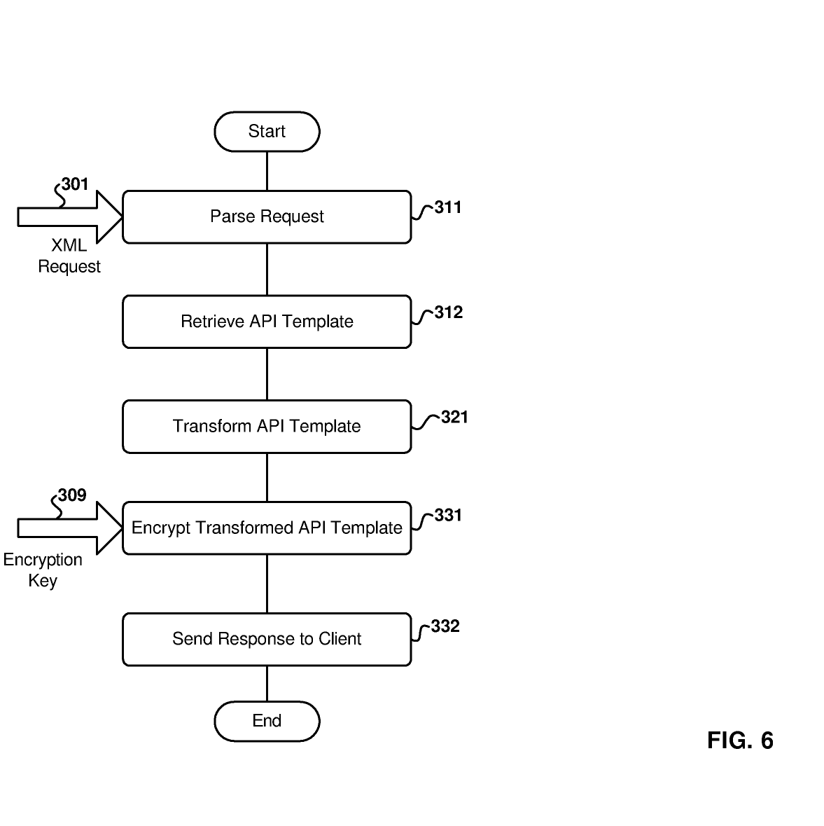

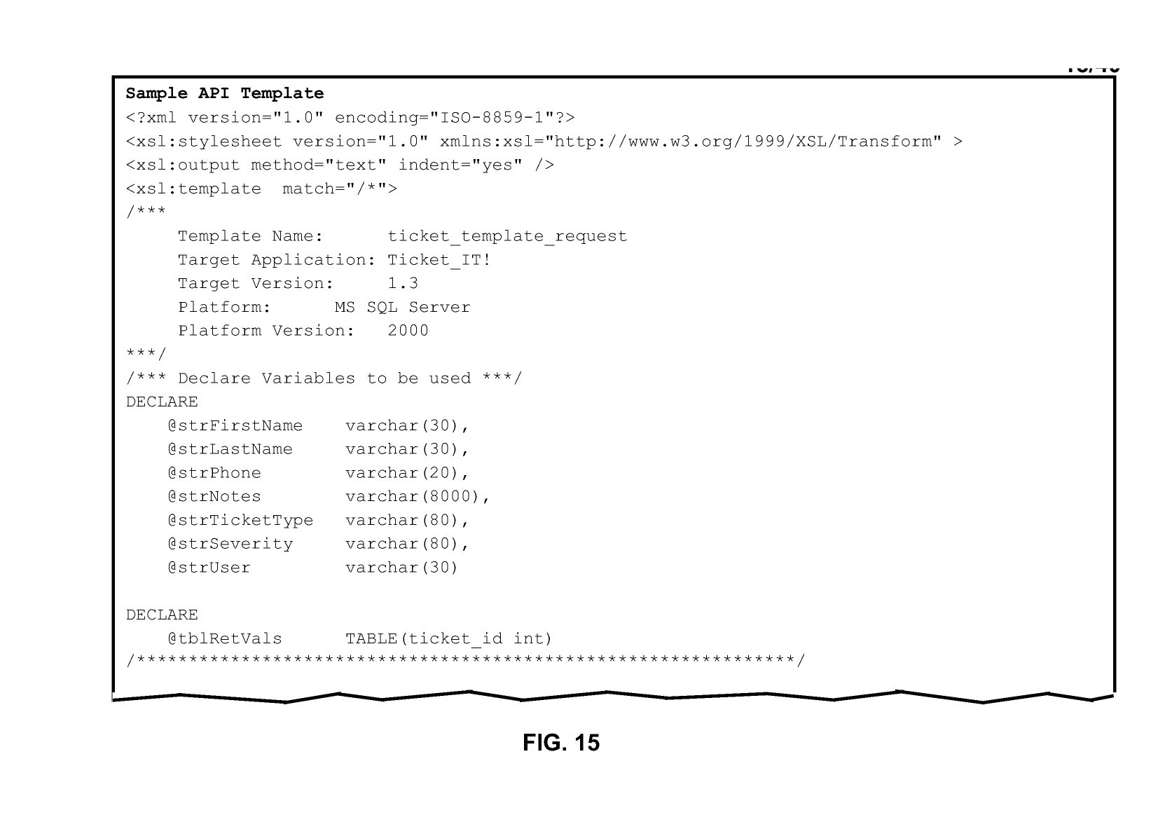

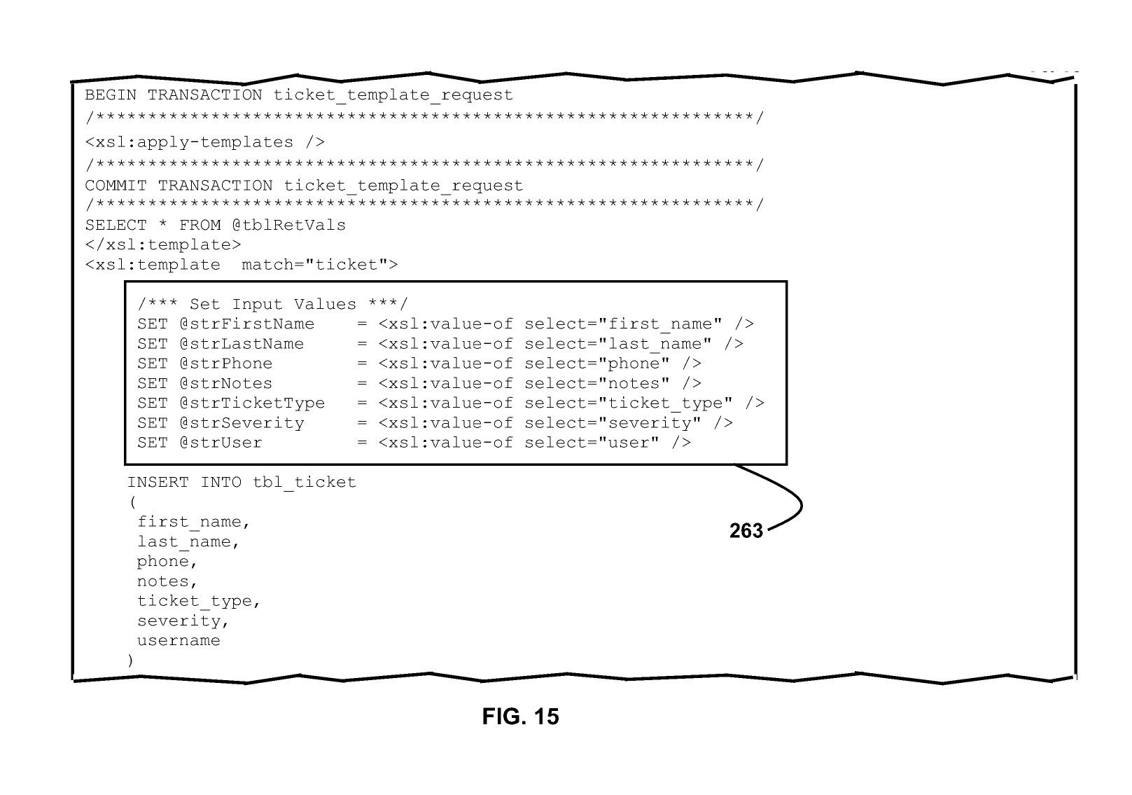

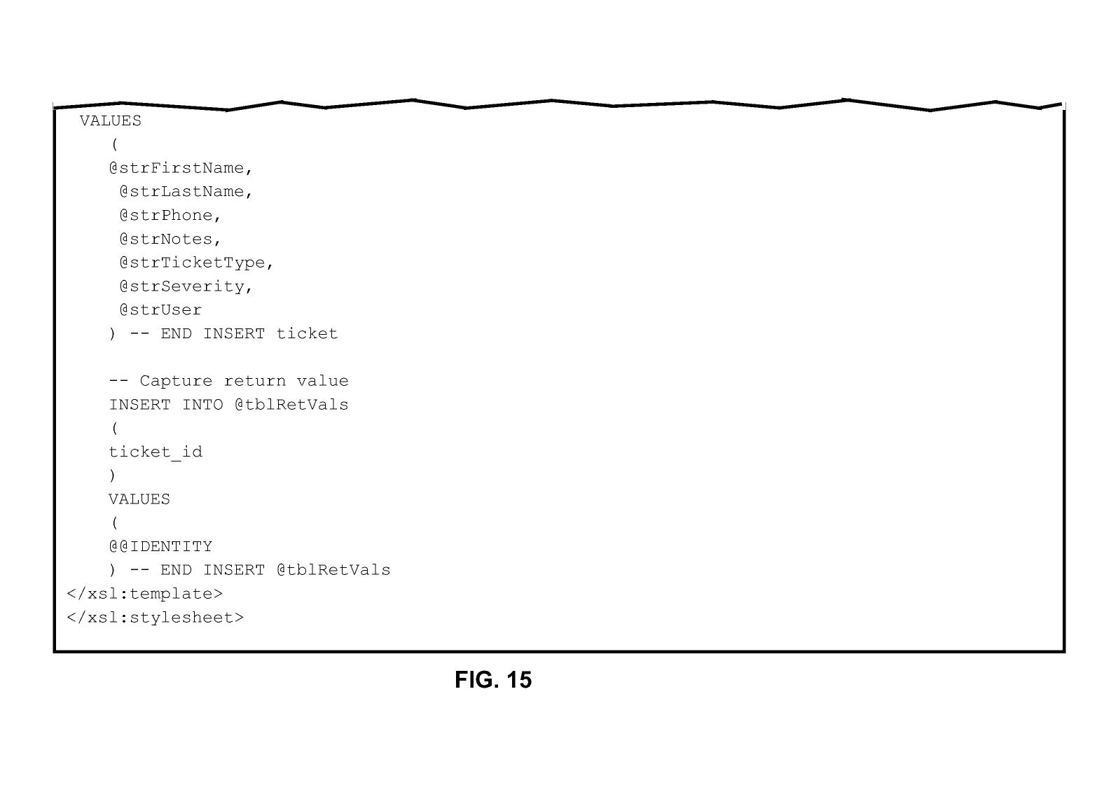

Preferably, Plug-In API Request 240 is acted upon by API Generator 106 and the appropriate Plug-In API Template 202 is preferably retrieved from API Templates Database 201. Preferably, API Generator 106 completes the steps described with reference to FIG. 5 and FIG. 6. An example of Plug-In API Template 202 is provided in FIG. 15 (FIG. 15 shows an example of a preferred embodiment which contains SQL stored as an XSL template). As shown in FIG. 15, Variables Mappings 263 illustrates how XML request elements are preferably mapped to their corresponding SQL variables (at least herein embodying computer-generating, by such at least one host database-management-functions provider, of such requested at least one database management function from such at least one program-code module; at least herein embodying wherein such step of computer-generating, by such at least one host database-management-functions provider, of such requested at least one database management function from such at least one program-code module is completed within at least one host network, controlled by such at least one host database-management-functions provider). Upon reading the teachings of this specification, those with ordinary skill in the art will now understand that, under appropriate circumstances, considering issues such as database management system requirements, changes in technology and database access methods, etc., other database access languages, such as, for example, C#, PERL, etc., may suffice.

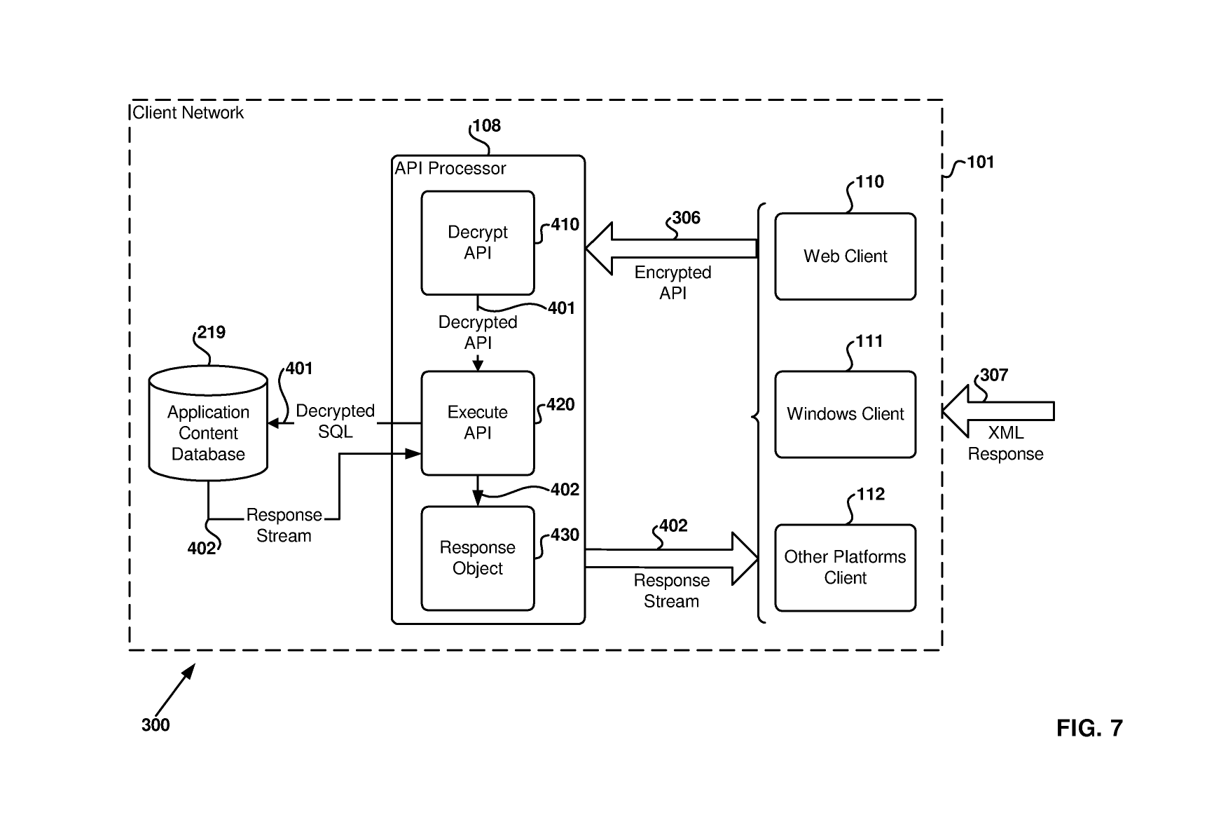

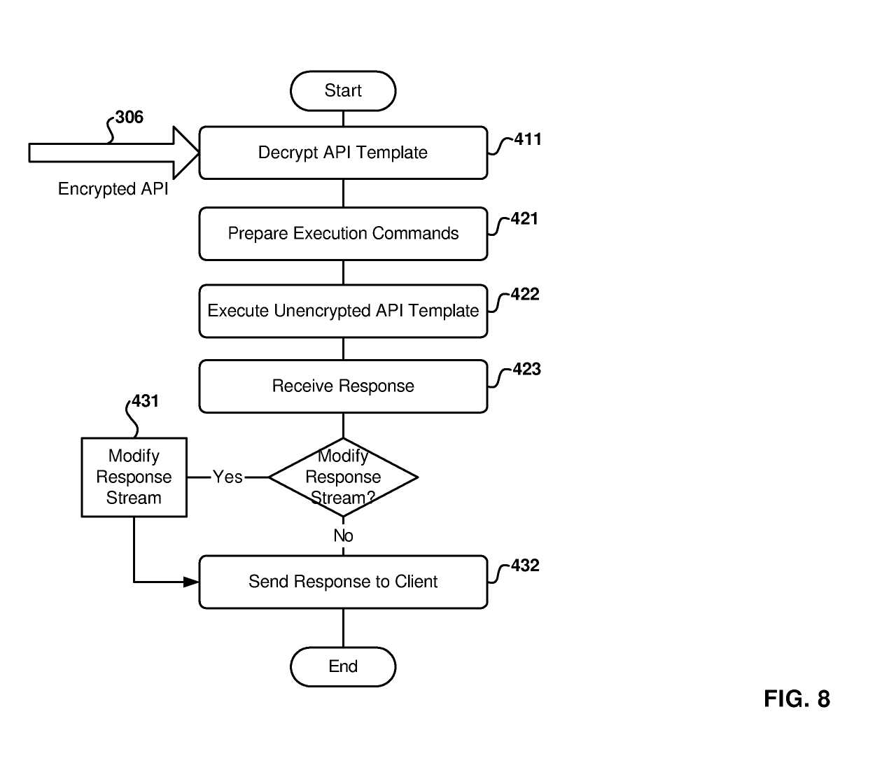

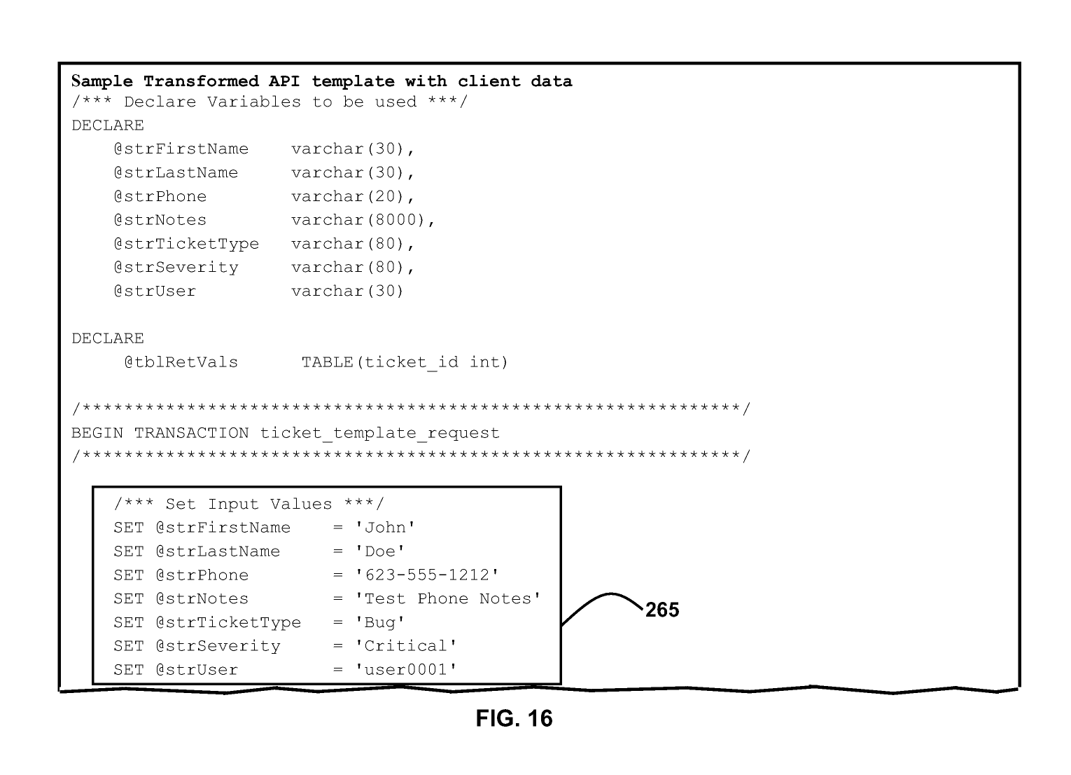

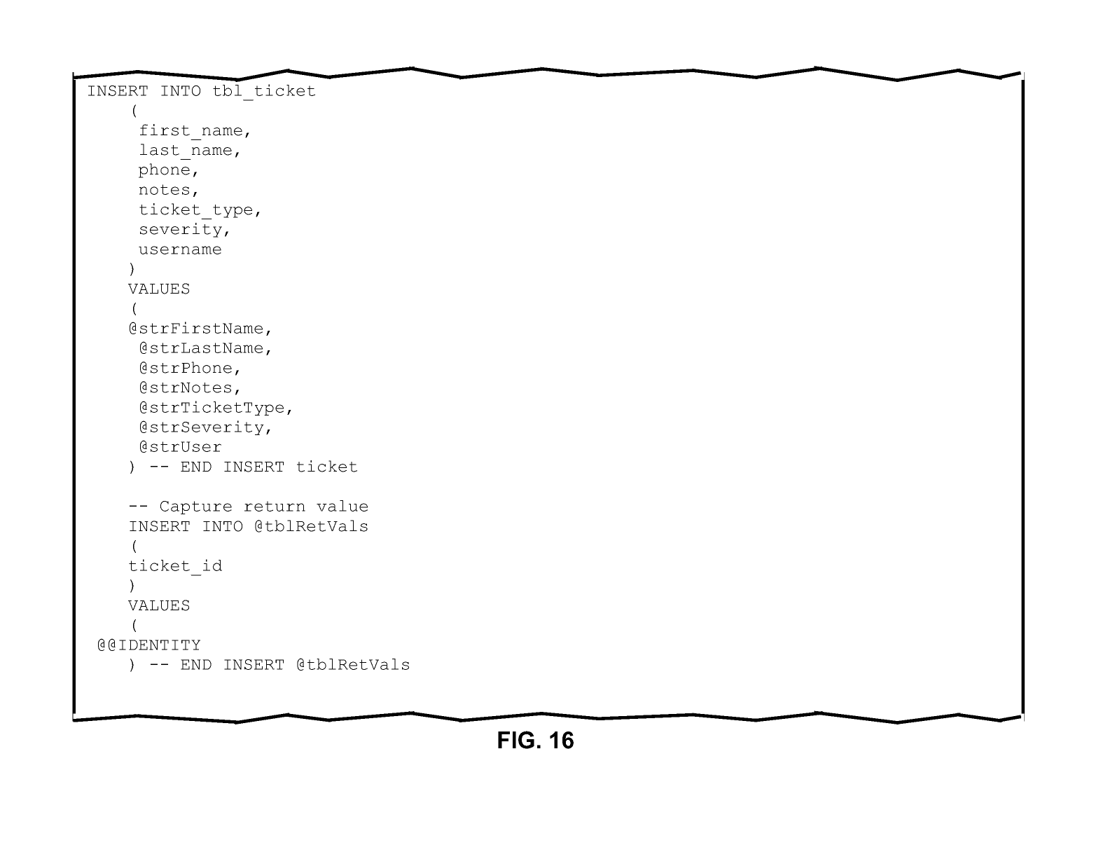

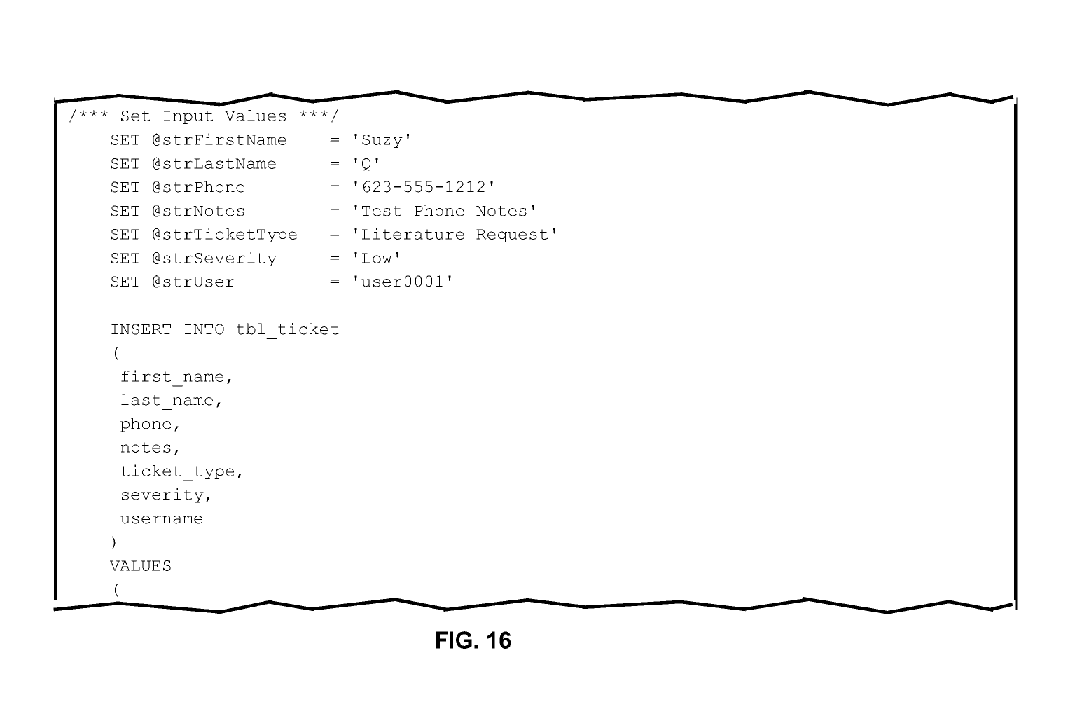

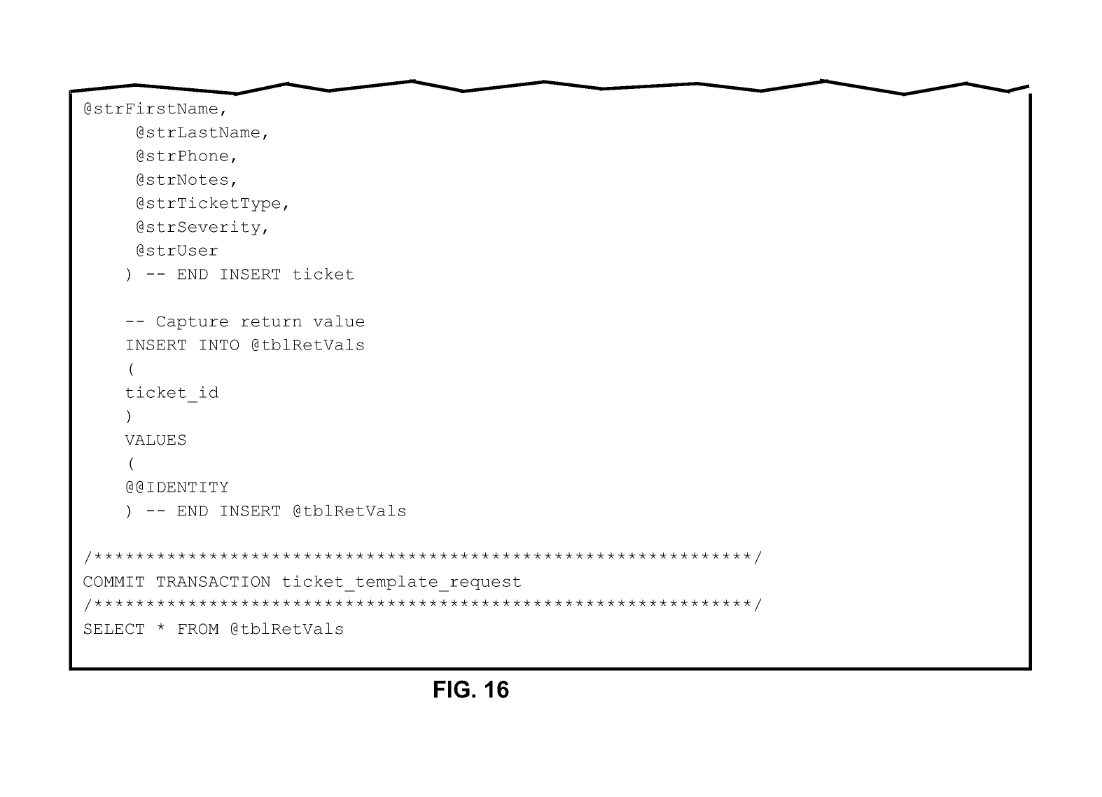

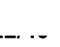

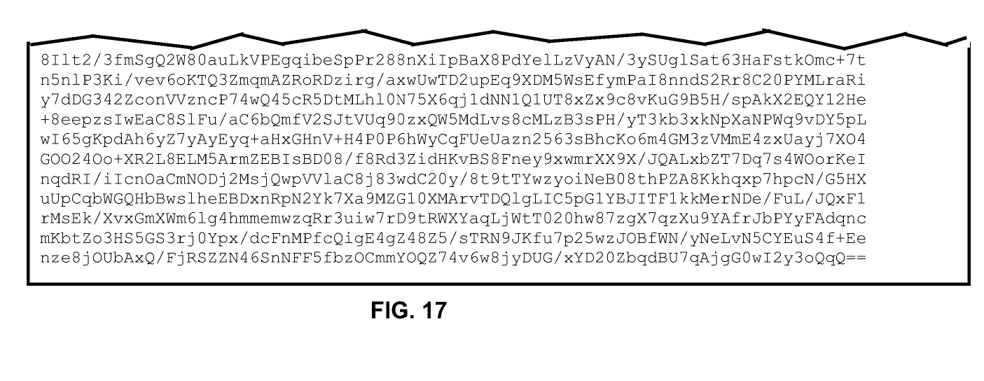

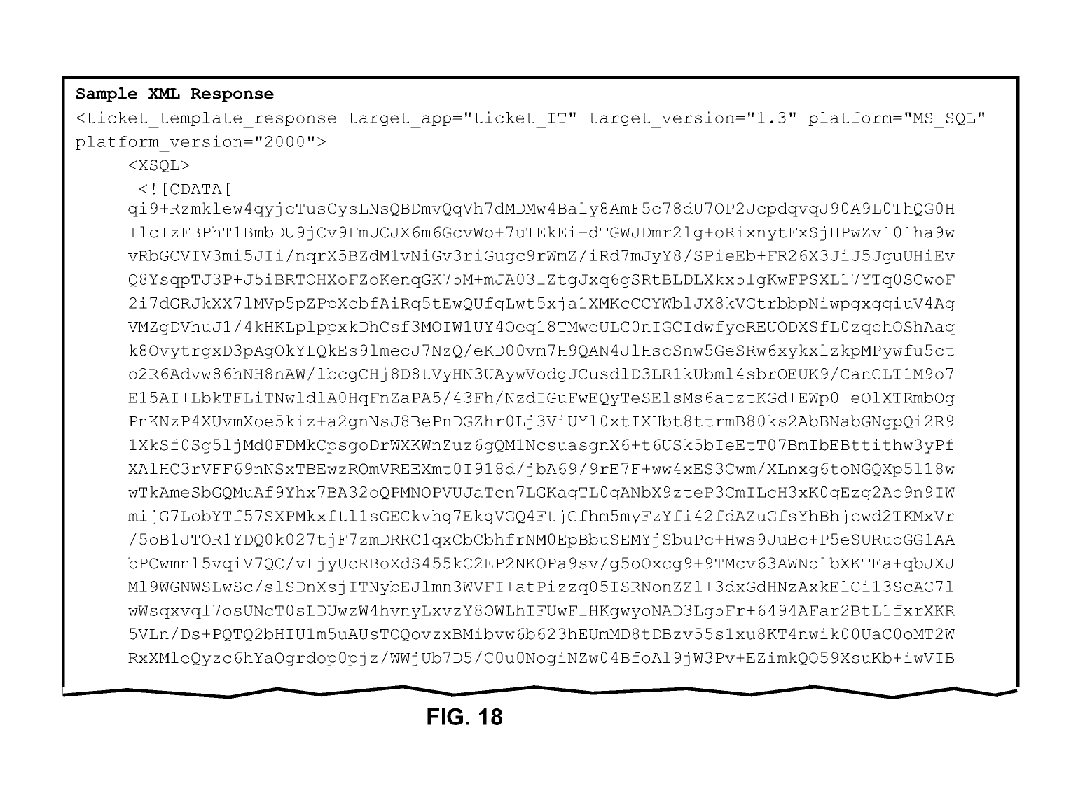

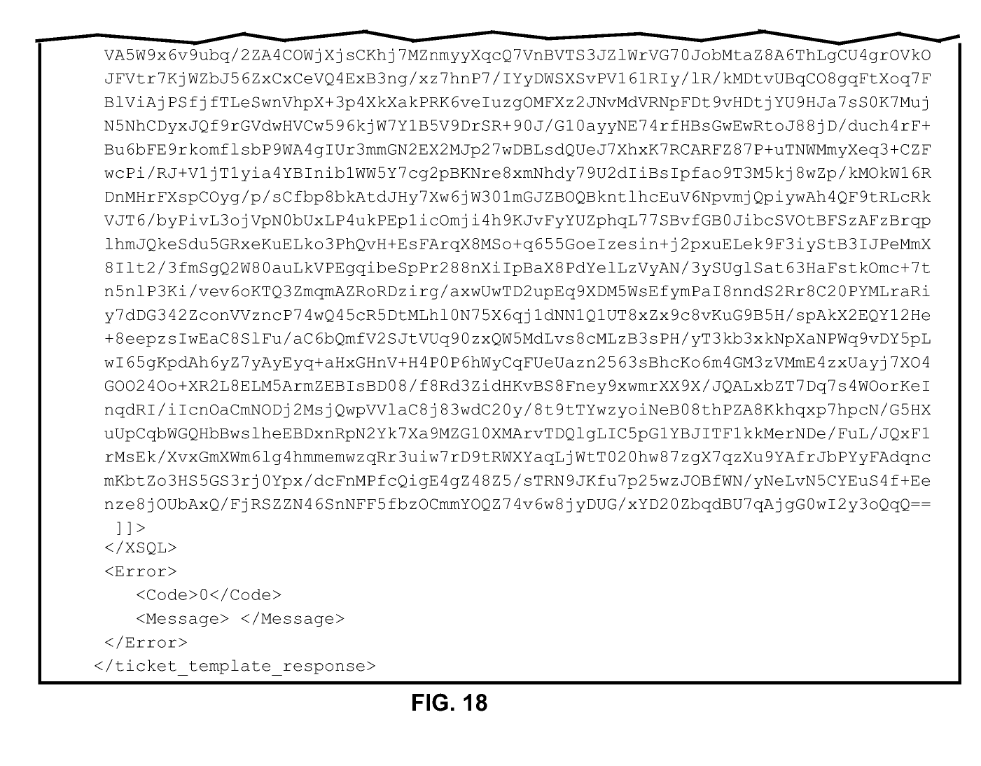

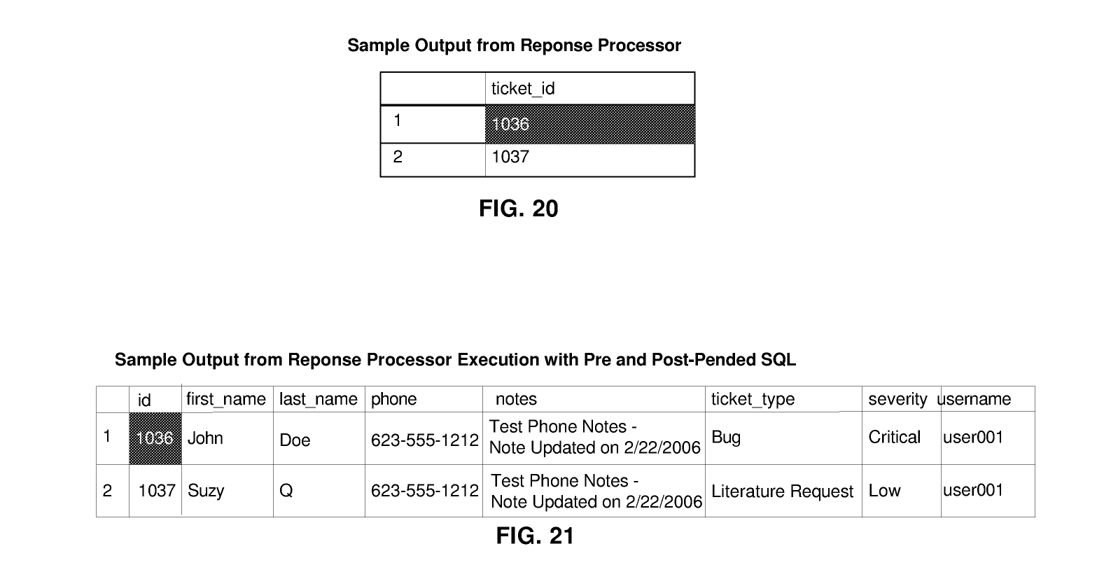

An example of Plug-In API Template 202 after transformation with client data is provided in FIG. 16 and an example of an encrypted transformed Plug-In API Template 202 is shown in FIG. 17. Preferably, API Generator 106 transmits Encrypted Plug-in API 242 (an example of which is shown in FIG. 18) to the client environment of User A 220 where Local Request 243 preferably requests execution API Processor 108 using encrypted transformed Plug-In API Template 202 via Local Call 209. Preferably, API Processor 108 is implemented as a stored procedure residing within Application Content Database 219. Preferably, API Processor 108 decrypts Encrypted Plug-In API 242 and preferably completes execution of decrypted transformed Plug-In API Template 202 against Application Content Database 219 and preferably returns results as Local Response 244 which are in turn preferably presented to User A 220 as Plug-In Task Response 224, and example of which is shown in FIG. 20 and FIG. 21. Preferably, details of the processing steps followed by API Processor 108 are as described in more detail with reference to FIG. 7 and FIG. 8 (at least herein embodying transmitting, by such at least one host database-management-functions provider, such requested at least one database management function to such at least one client user; at least embodying herein wherein such at least one function processor is structured and arranged to hide such assigned at least one encryption key from such at least one client user).

Preferably, Standalone API Request 245 is acted upon by API Generator 106 and the appropriate Standalone API Template 203 is preferably retrieved from API Templates Database 201. Preferably, API Generator 106 completes the steps described with reference to FIG. 5 and FIG. 6. An example of Standalone API Template 203 is provided in FIG. 15. An example of Standalone API Template 203 after transformation with client data is provided in FIG. 16 and an example of an encrypted transformed Standalone API Template 203 is shown in FIG. 17. Preferably, API Generator 106 transmits Encrypted Standalone API 246 (an example of which is shown in FIG. 18) to the client environment of User B 221 where Local Request 247 preferably requests execution API Processor 108 preferably using encrypted transformed Standalone API Template 203 via Local Call 209. Preferably, API Processor 108 is implemented as a stored procedure residing within Application Content Database 219. Preferably, API Processor 108 decrypts Encrypted Standalone API 246, preferably completes execution of decrypted transformed Standalone API Template 203 against Application Content Database 219, and preferably returns results as Local Response 248, which are in turn preferably presented to User B 221 as Standalone Task Response 225, an example of which is shown in FIG. 20 and FIG. 21. Preferably, details of the processing steps followed by API Processor 108 are as described in more detail with reference to FIG. 7 and FIG. 8 (at least herein embodying empowering, by such at least one host database-management-functions provider, of such at least one client user, to computer-execute such at least one transmitted database management function; at least herein embodying wherein such step of computer-executing, using such transmitted at least one function processor, such decrypted at least one database management function on behalf of such at least one client user is completed within at least one client network, controlled by such at least one client user).

Referring to FIG. 5, which shows a schematic diagram of data flow and component operation of API Generator Sub-process 200 of Database Management Function Provider Systems, according to a preferred embodiment of the present invention, XML Request 301 (see FIG. 14) is preferably received by Web Service 122. Preferably, Web Service 122 retrieves the encryption key associated with User A 220 or User B 221 preferably based on License Key 260 provided as part of XML Request 301. As depicted in FIG. 14, User A 220 or User B 221 has also preferably provided Environmental Parameters 261 which are necessary to retrieve appropriate API Template 304. Preferably, Environmental Parameters 261 includes target application (Clarify, PeopleSoft, etc.), target application version (10.0, 12.1, etc.), database management system (platform) (Microsoft SQL Server, Oracle, etc.) and database management system version (platform version) (2000, 8i, 10g, etc.)

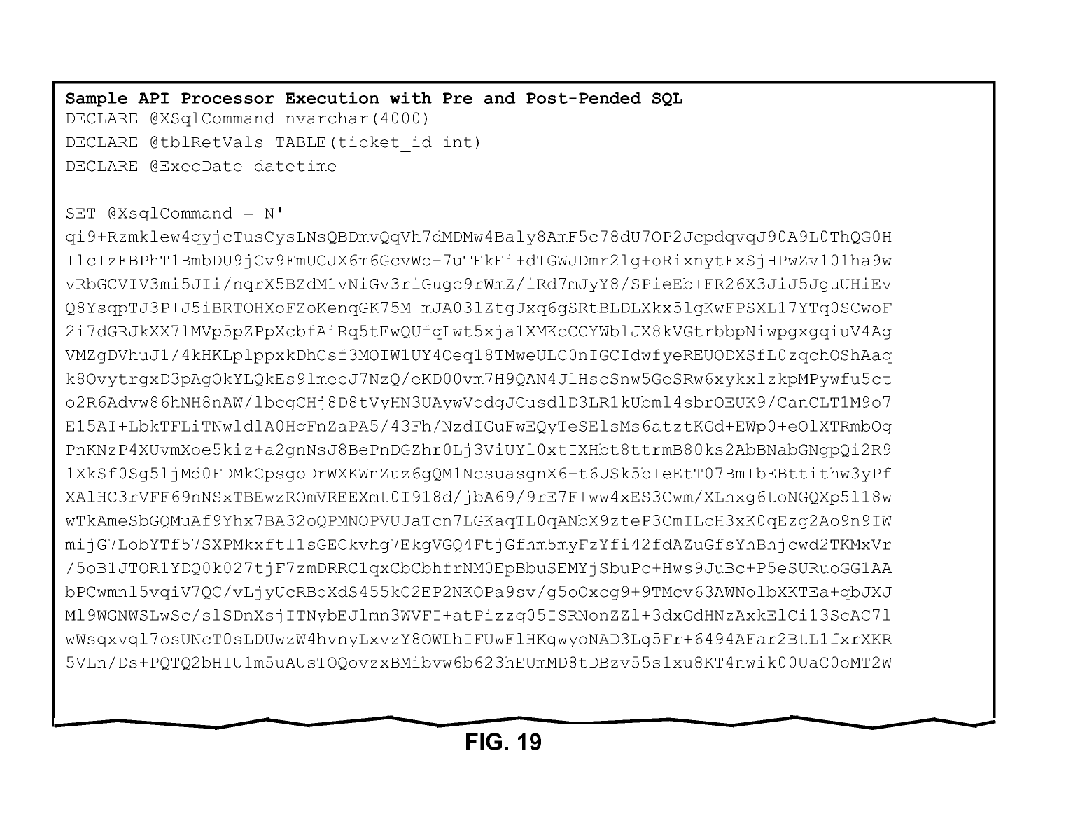

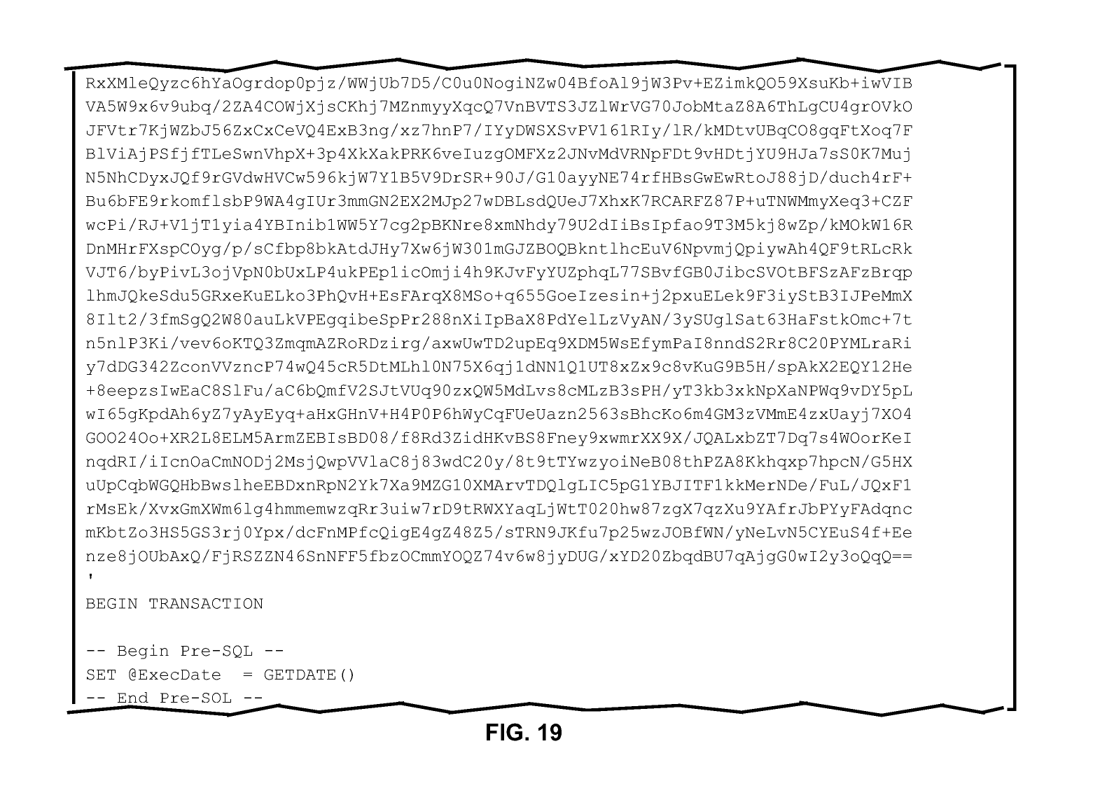

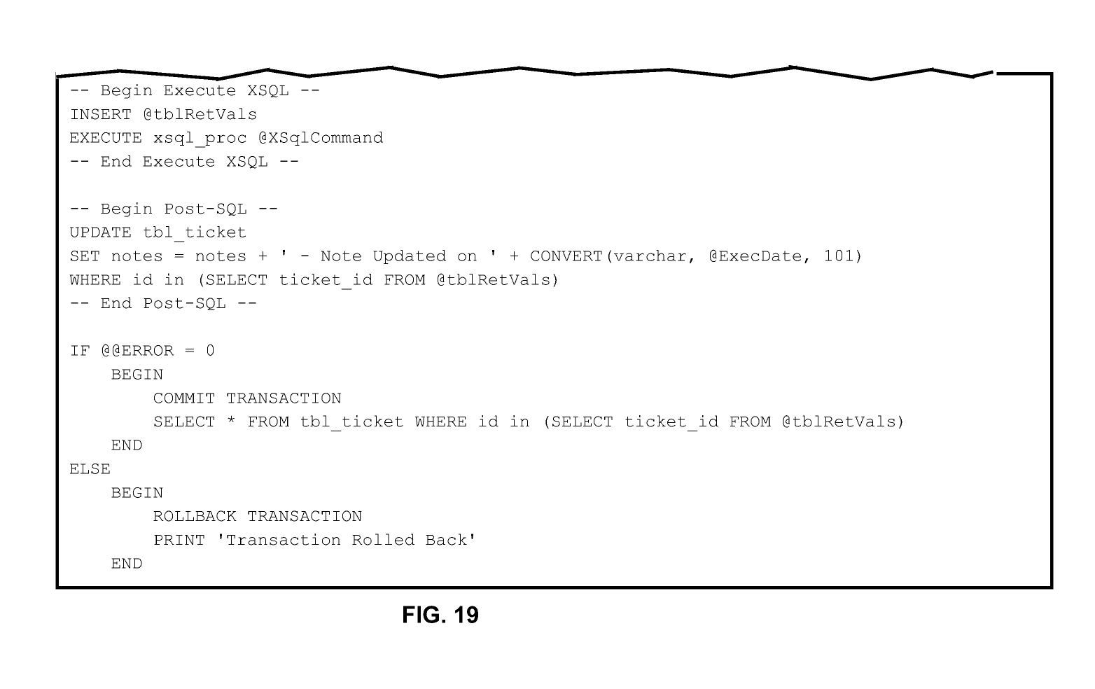

Preferably, User A 220 or User B 221 may provide custom database commands (SQL) preferably to be executed before (pre-pended database commands) or after (post-pended database commands) execution of selected API Template 304 by API Processor 106. This allows User A 220 and/or User B 221 to modify the output that is produced when API Template 304 is executed. (Refer to FIG. 19)

Preferably, XML Request 301 and encryption key are passed to module Retrieve Template 310 of API Generator 106. (Preferably, module Retrieve Template 310 encompasses logic steps Parse Request 311 and Retrieve API Template 312, as shown in FIG. 6.) Preferably, module Retrieve Template 310 parses Environmental Parameters 261 contained within XML Request 301 to formulate an API Template Query 303 and preferably retrieve API Template 304 with appropriate Variables Mappings 263 (see FIG. 15) from the API Templates Database 201, which is appropriate for Application 230 and Application Content Database 219. Preferably, API Provider System Owner 902 (also referred to herein as host database-management-functions provider) maintains at least one API Template 304 version for primary combinations of Application 230 and database management system used for Application Content Database 219.

Preferably, API Template 304 is then passed to module Transform Template 320. (Preferably, module Transform Template 320 encompasses logic step Transform API Template 321, as shown in FIG. 6.) Preferably, Transform Template 320 transforms the XML Request 301 with the API Template 304 preferably embedding Client Data 262 as Input Values 265 within transformed API Template 304 (see FIG. 16) (at least herein embodying receiving, by such at least one host database-management-functions provider, of client data relating to such requested database management function and relating to such at least one client content database, from such at least one client user; and at least herein embodying computer-generating, by such at least one host database-management-functions provider, of at least one database management function; and at least herein embodying wherein such computer-generated at least one database management function comprises such received client data; and at least herein embodying wherein such computer-generated at least one database management function comprises such requested at least one database management program-code module).

Preferably, transformed API template 304 is then passed to module Encrypt Template 330. (Preferably, module Encrypt Template 330 encompasses logic steps Encrypt Transformed API Template 331 and Send Response to Client 332, as shown in FIG. 6.) Module Encrypt Template 330 preferably uses Encryption Key 309 associated with User A 220 or User B 221, preferably encrypting transformed API Template 304 to create Encrypted API 306 (see FIG. 17). Preferably, Encrypted API 306 is then passed to the Web service 122 which then preferably returns it with appropriate XML as XML Response 307 (refer to FIG. 18) to the client computer of User A 220 or User B 221 (at least herein embodying encrypting, by such at least one host database-management-functions provider, of such at least one computer-generated database management function, using such assigned at least one encryption key).

Referring to FIG. 7, which shows a schematic diagram of data flow and component operation of API Processor Sub-process 300 of Database Management Function Provider Systems, according to a preferred embodiment of the present invention, preferably API Processor 108 is implemented as a “set of program logic” which resides within Application Content Database 219 as a stored procedure. Preferably, API Processor 108, operating as a stored procedure, has direct access to the Application Content Database 219. Upon reading the teachings of this specification, those with ordinary skill in the art will now understand that, under appropriate circumstances, considering issues such as customer requirements, competition, introduction of new database technologies, etc., other implementation architectures, such as, for example, API processor operating as an independent program, etc., may suffice.

As described above, preferably User A 220 and User B221 each have Encryption Key 309 uniquely created and associated with them when they subscribe to use Database Management Function Provider Systems 100. Preferably, Encryption Key 309 used by API Generator 106 to create Encrypted API 306 for User A 220 is also embedded within API Processor 108 created for User A 220 and similarly for User B 221. (User A 220, User B 221 and Organization 901 may also be referred to collectively as Subscriber 602 when no distinction is required.) Therefore, API Processor 108 is preferably created uniquely for each subscriber and is preferably able to decrypt Encrypted API 306 template produced by the API Generator 106. Preferably, the encryption algorithm used is the symmetric key AES/Rijndael algorithm. Upon reading the teachings of this specification, those with ordinary skill in the art will now understand that, under appropriate circumstances, considering issues such as customer requirements, application requirements, changes in technology, etc., other reversible encryption methods, such as, for example, 3DES, RSA, etc., may suffice. As discussed, preferably each version of the API Processor 108 made available to subscriber has unique Encryption Key 309, for subscriber, embedded within it. Upon reading the teachings of this specification, those with ordinary skill in the art will now understand that, under appropriate circumstances, considering issues such as security requirements, changes in database management architectures, changes in wide area network architectures, etc., other methods of providing the encryption key to API Processor, such as, for example, encryption request and response from an external source, etc., may suffice.

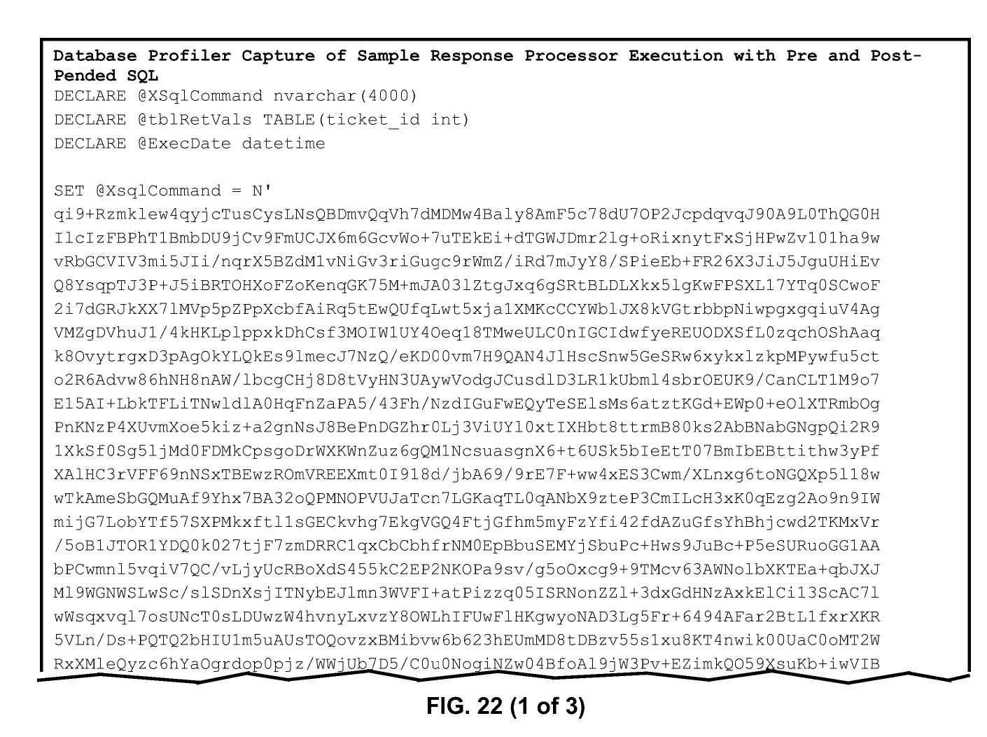

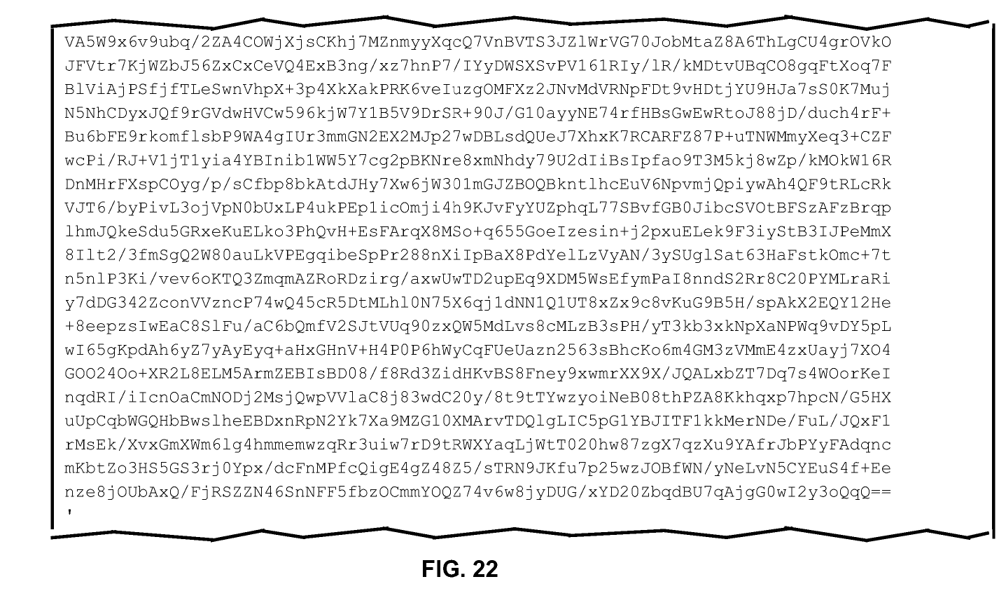

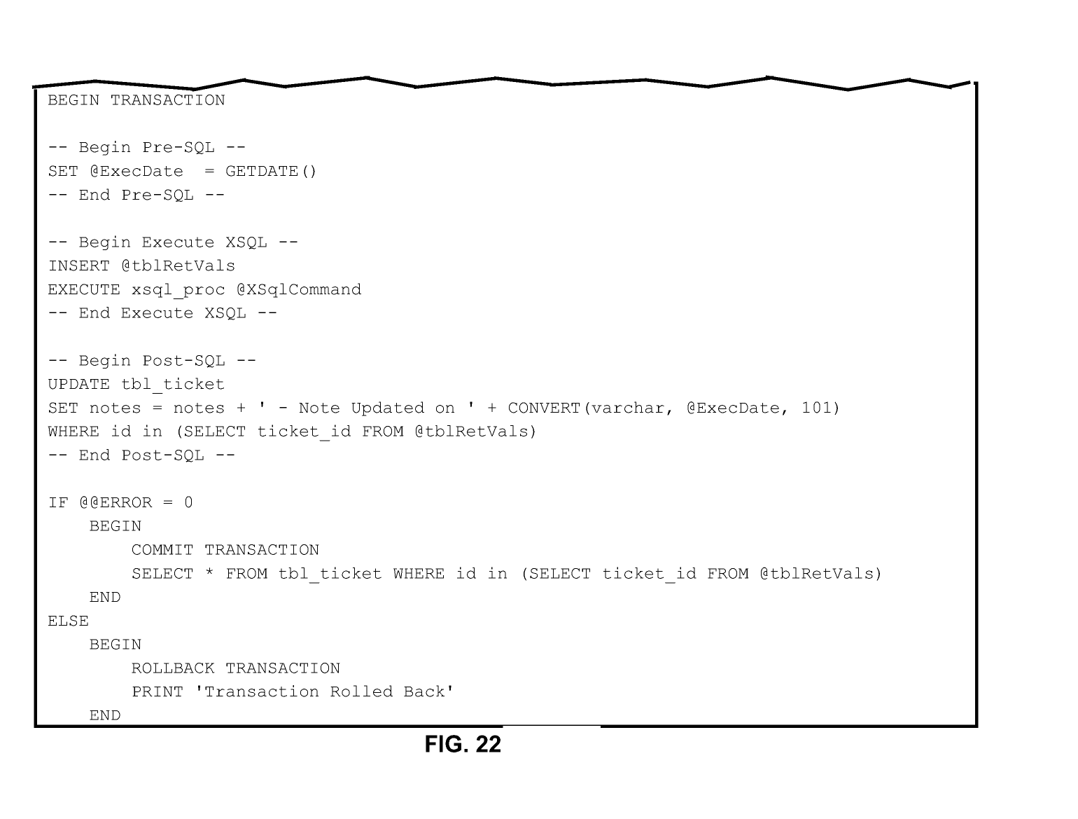

Preferably, API Processor 108 decrypts and executes the Encrypted API 306 in a manner that the decrypted and executed database (SQL) commands contained within Encrypted API 306 are completely hidden from subscriber and database tools designed to capture and display executed database commands. Preferably, not permitting disclosure of executed database commands provides a preferred method for ensuring control of use of API Template 304 and avoiding disclosure of trade secrets (at least herein embodying enabling decrypting, by such transmitted at least one function processor, of such encrypted at least one database management function, using such assigned at least one encryption key). (Refer to FIG. 22)

Preferably, in summary, on receipt of XML Response 307 API Processor 108 decrypts and executes Encrypted API 306. Preferably, execution of API template 304 produces output providing information about the data that was modified or created in the Application Content Database 219. As an example, this output may preferably be the unique identifier for rows affected by the execution of the API template (at least herein embodying enabling computer-executing, using such transmitted at least one function processor, of such decrypted at least one database management function on behalf of such at least one client user).

Preferably, on receipt of XML Response 307, Web Client 110, Windows Client 111 or Other Platforms Client 112 calls API Processor 108, preferably passing it, Encrypted API 306, and any pre-pended database commands to be executed before API Template 304 and/or any post-pended database commands that should be executed after the API Template 304. Preferably, module Decrypt API 410 decrypts Encrypted API 306 and preferably passes Decrypted API 401, (transformed API Template 304), to module Execute API 420 (at least herein embodying permitting, by such at least one host database-management-functions provider, providing at least one database command by such at least one client user to be included for determined sequential computer-execution within such computer-generated at least one database management function). (Preferably, module Decrypt API 410 encompasses logic step Decrypt API Template 411 as shown in FIG. 8.)

Preferably, module Execute API 420 then prepares any prefixed commands, the commands contained within the decrypted API template, and any post-pended commands for execution within Application Content Database 219. Preferably, prepared commands are then executed against Application Content Database 219 and the results produced by the pre-pended database commands, API Template 304 database commands, and post-pended database commands are preferably sent as Response Stream 402 to module Execute API 420 which then preferably passes Response Stream 402 to the module Response Object 430. (Preferably, module Execute API 420 encompasses logic steps Prepare Execution Commands 421, Execute Unencrypted API Template 422 and Receive Response 423 as shown in FIG. 8.)

Preferably, module Response Object 430 modifies the Response Stream 402, if necessary, and passes Response Stream 402 to Web Client 110, Windows Client 111 or Other Platforms Client 112. (Preferably, module Response Object 430 encompasses logic steps Modify Response Stream 431 and Send Response to Client 432 as shown in FIG. 8.) Preferably, modification of Response Stream 402 is optional. Preferably, if no modifications are required by Web Client 110, Windows Client 111 or Other Platforms Client 112, Response Stream 402 is not altered. In other cases, conversion of Response Stream 402 is required, for example conversion from a tabular data stream to comma-separated values, by Response Object 430 (at least herein embodying enabling presenting of at least one result of such computer-execution of such transmitted database management function to such at least one client user).

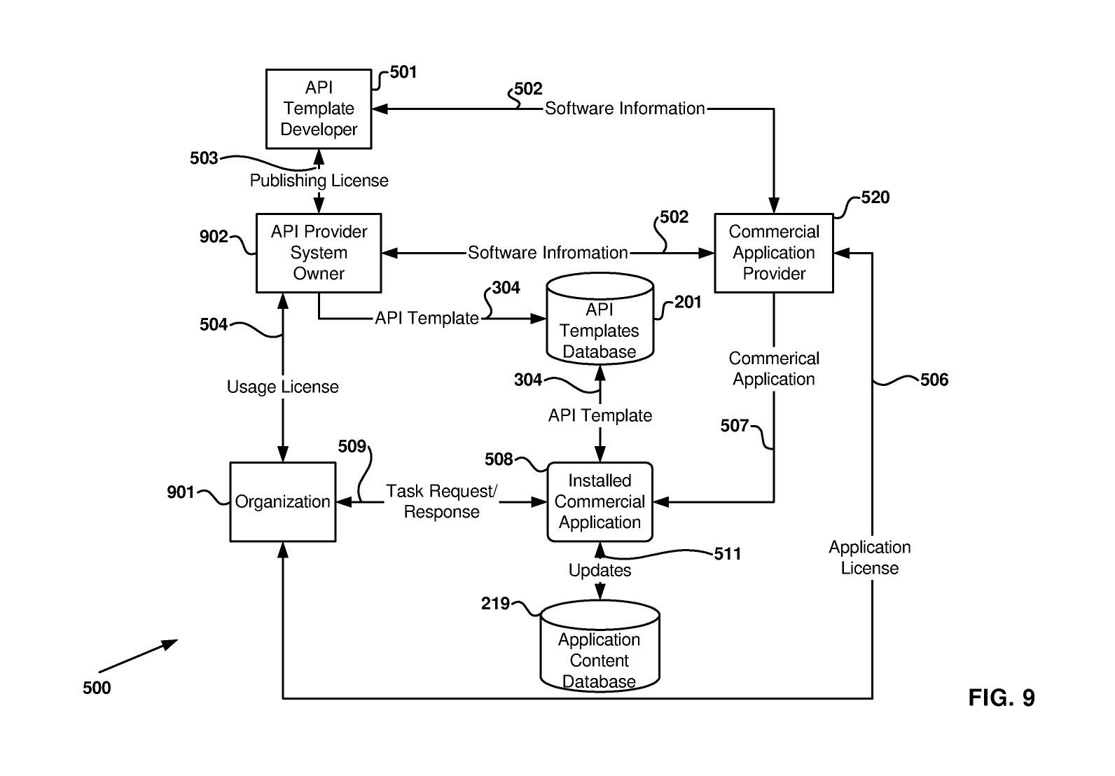

Referring to FIG. 9, which shows a schematic diagram of Subscription Business Method 500 associated with Database Management Function Provider Systems, according to a preferred embodiment of the present invention, API Provider System Owner 901 preferably obtains Software Information 502 from Commercial Application Provider 520 (representative of a variety of software providers including companies such as JD Edwards, PeopleSoft, Seibel and others) regarding methods of database and application operation and design for the purpose of creating API Template 304 (representing any number of diverse and useful database management functions) for creating and maintaining API Templates Database 201. Additionally, API Provider System Owner 902 will preferably complete Publishing License 503 with one or more API Template Developers 501 for the purpose of securing additional API Templates 304 for inclusion in API Templates Database 201. Preferably, Publishing License 503 will permit API Provider System Owner 902 to make API Templates 304 available to Organization 901; and, in return, API Provider System Owner 902 will preferably pay API Template Developer 501 a royalty fee (at least herein embodying securing, by such at least one host database-management-functions provider, of at least one program-code module structured and arranged to interact with such at least one client content database).

As shown, Organization 901 preferably obtains an Application License 506 from Commercial Application Provider 520 which in turn preferably provides Commercial Application 507 to Organization 901. Preferably, Organization 901 implements Commercial Application 507 as Installed Commercial Application 508. At the time of implementation or subsequently, Organization 901 may preferably determine the need for API Templates 304 to accomplish one or more tasks not provided by Installed Commercial Application 508.

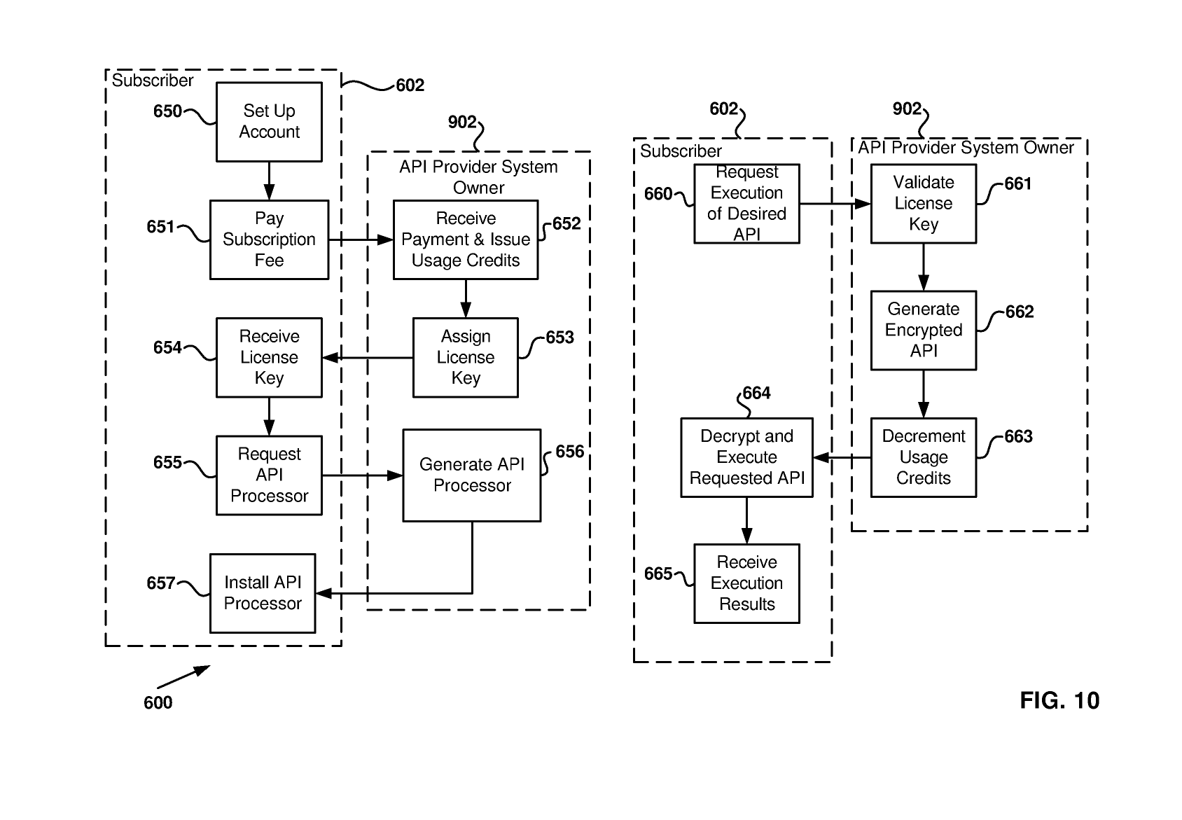

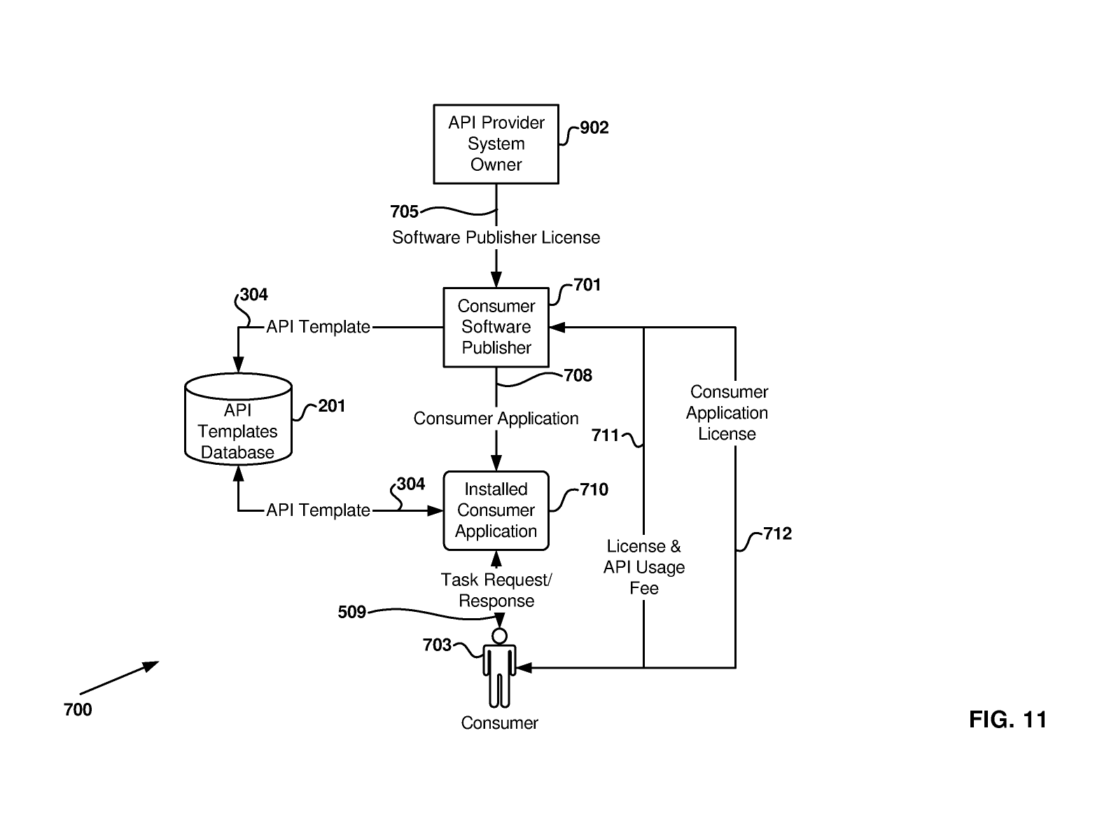

Preferably, API Provider System Owner 902 will offer access (to API Templates 304 stored API Templates Database 201) to Organization 901 and its members preferably in return for a subscription fee based on usage of API Templates 304. Reference is made to discussion with reference to FIG. 10 for preferred subscription methods.

Preferably, completion of Usage License 504 between API Provider System Owner 902 and Organization 901 will permit access to API Templates 304 stored in API Templates Database 201. Preferably, members of Organization 901 will then request API Templates 304 from API Templates Database 201 in conjunction with use of Installed Commercial Application 508 and receive results of execution of API Templates 304, collectively Task Request/Response 509. Preferably, usage will be as described with reference to FIG. 4, FIG. 5, FIG. 7 and FIG. 10. Preferably, results of execution of API Templates 304 may result in Updates 511 being made to Application Content Database 219.

Referring to FIG. 10, which shows a schematic diagram of Subscription Licensing Process 600 for use of Database Management Function Provider Systems as part of Subscription Business Method 500, according to a preferred embodiment of the present invention, preferably, usage of Database Management Function Provider Systems 100 is permitted only through granting of a usage license on a subscription basis to Subscriber 602 (representative of User A 220, User B 221 or Organization 901) preferably in return for payment of appropriate license fees.

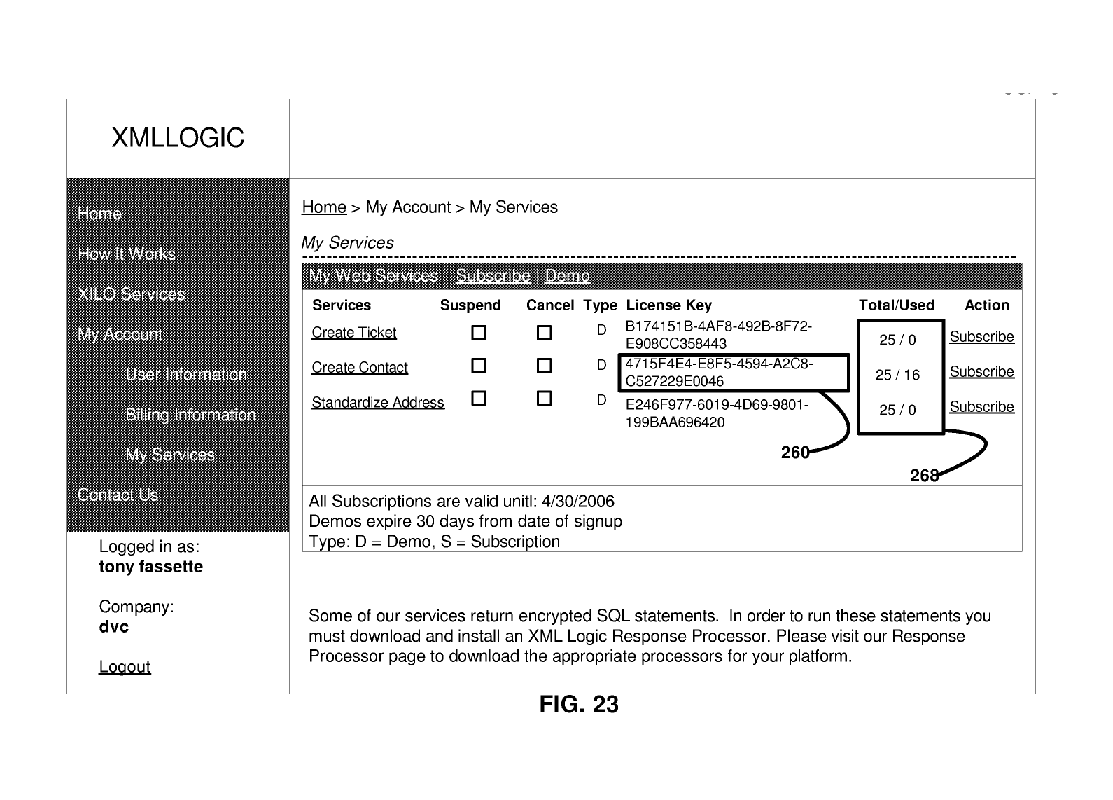

Preferably, in step Set Up Account 650, Subscriber 602 establishes an account with API Provider System Owner 902 preferably by providing requested name and address information. Preferably, in step Pay Subscription Fee 651, each Subscriber 602 (representative of User A 220, User B 221 and Organization 901) estimates monthly usage of each available Web Services (API Template) and preferably calculates expected Usage Credits 268 required each month. Preferably, each Subscriber 602 then agrees to make a monthly payment to API Provider System Owner 902 to purchase the required number of usage credits. As shown in step Receive Payment & Issue Usage Credits 652, upon receipt of payment, API Provider System Owner 902 preferably issues the number of purchased Usage Credits 268 and will preferably continue to do so as long as the monthly fee is paid. Preferably, un-used usage credits are not carried over at the end of each month; however, Subscribers 602 will preferably be charged additional fees if actual Usage Credits 268 consumed exceed purchased Usage Credits 268. Reference is made to FIG. 23 for a display of Usage Credits 268.

Preferably, in step Assign License Key 653, API Provider System Owner 902 assigns each Subscriber 602 a unique license key which preferably must accompany each XML request for an API template. Refer to License Key 260 shown on FIG. 14 and FIG. 23. Preferably, API Provider System Owner 902 provides License Key 260 to Subscriber 602. Preferably, Subscriber 602 receives assigned License Key 260, as shown in FIG. 23, in step Receive License Key 654.

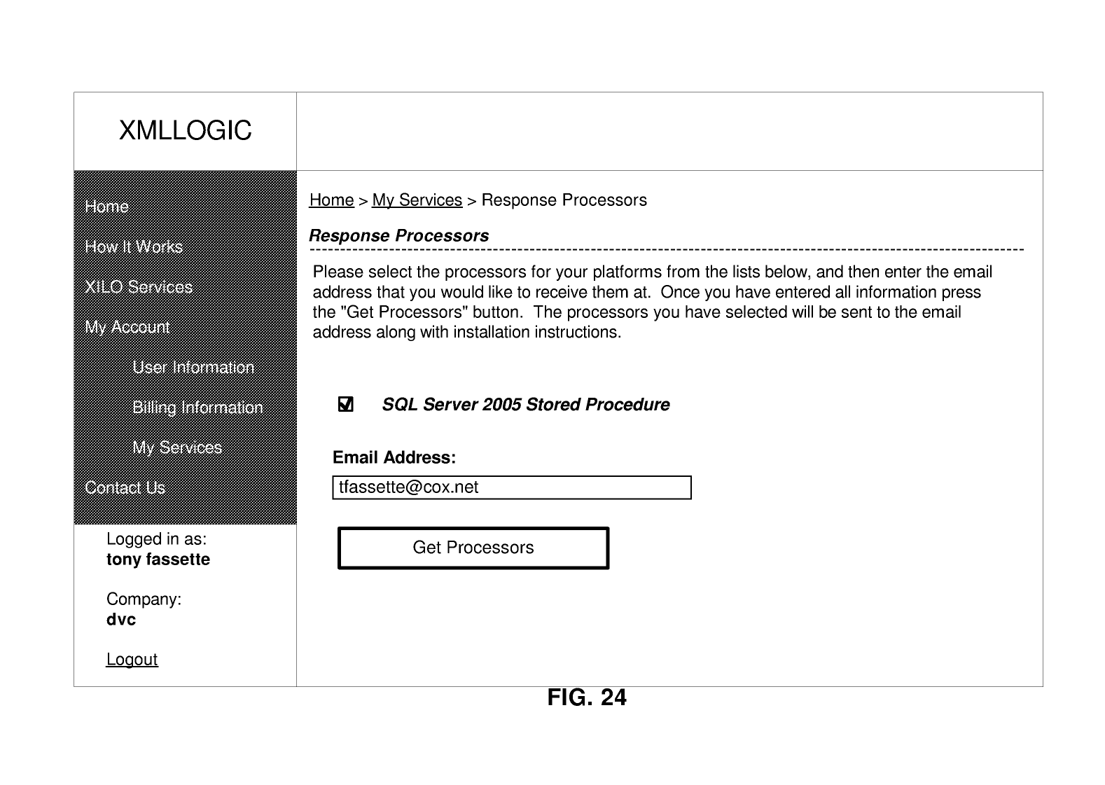

Preferably, once Subscriber 602 has received License Key 260, API Processor 108 preferably may be requested for installation to computer of Subscriber 602 in step Request API Processor 655. As shown in FIG. 24, Subscriber 602 must preferably indicate email address and database manager vendor and version with which requested API Processor 108 will be used.

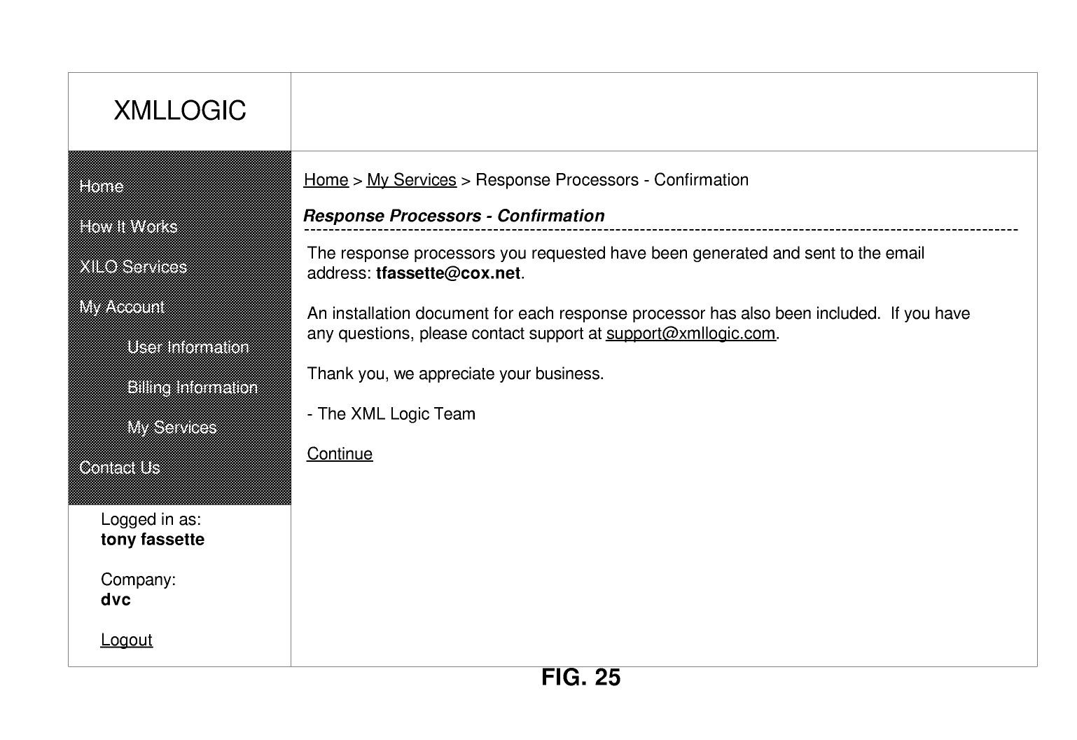

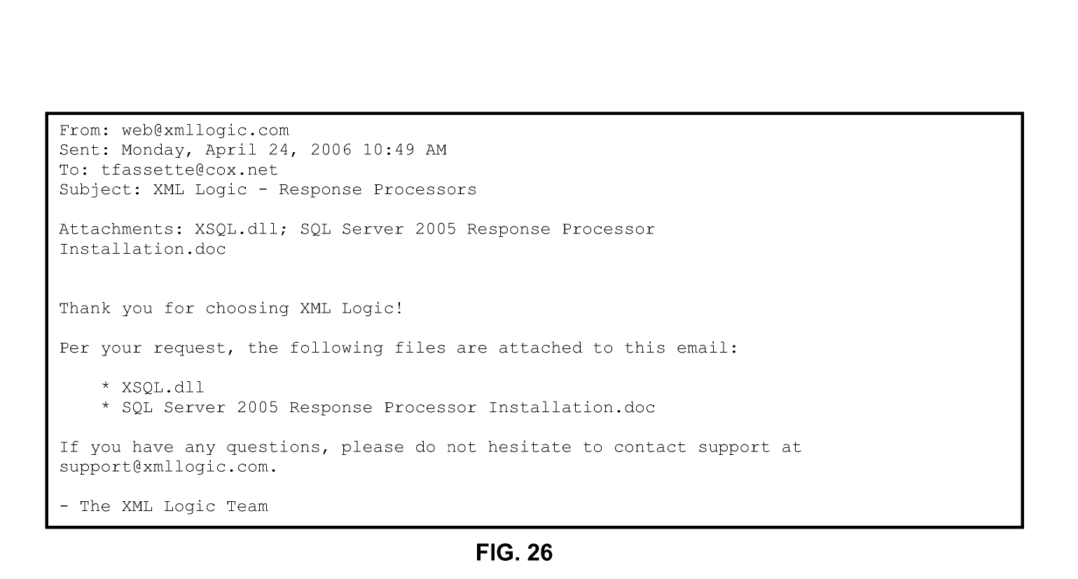

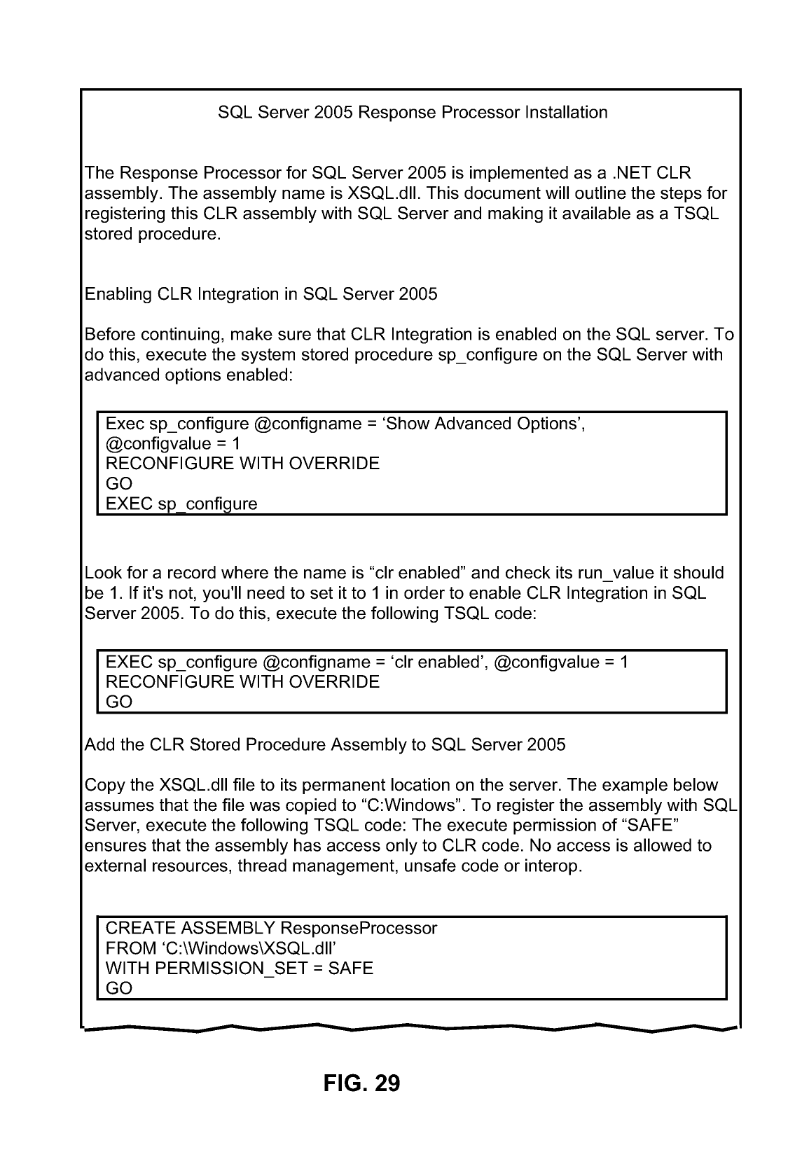

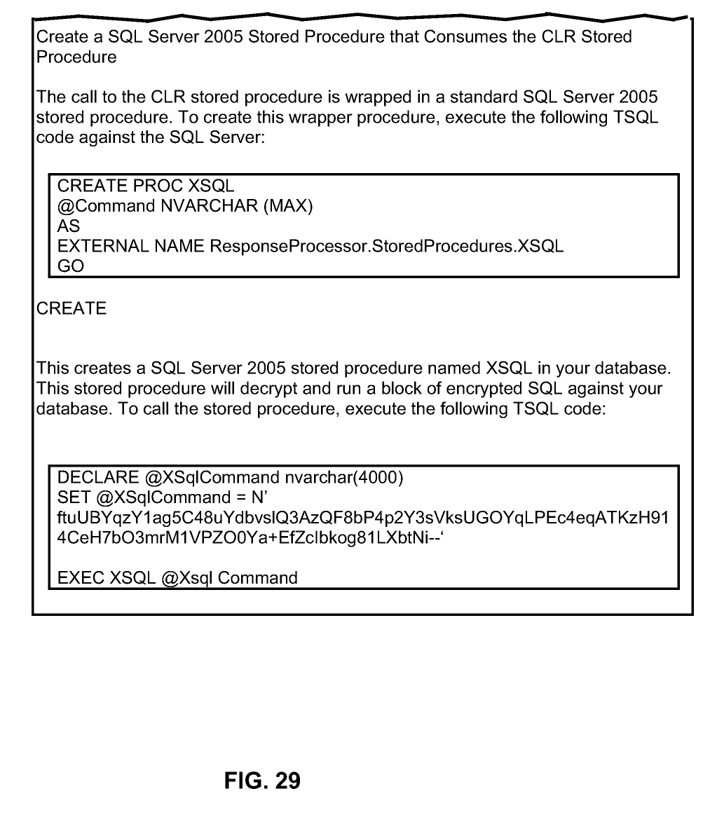

Preferably, API Provider System Owner 902 receives API Processor 108 request from Subscriber 602 and preferably generates an appropriate version of API Processor 108 in step Generate API Processor 656. Additionally, API Provider System Owner 902 preferably assigns Encryption Key 309 uniquely to each Subscriber 602 and preferably generates API Processor 108 with assigned Encryption Key 309 embedded. An example of the encryption algorithm used in this embodiment is the symmetric key AES/Rijndael algorithm, discussed above with reference to FIG. 7. Preferably, API Provider System Owner 902 generates a confirmation screen (see FIG. 25) and an email message with generated API Processor 108 and Installation Instructions attached (Refer to FIG. 26 and FIG. 29) (at least herein embodying assigning, by such at least one host database-management-functions provider, at least one unique encryption key to such at least one client user; and at least embodying herein transmitting, by such at least one host database-management-functions provider, of at least one function processor to such at least one client user; and at least embodying herein wherein such at least one function processor comprises such assigned at least one encryption key).

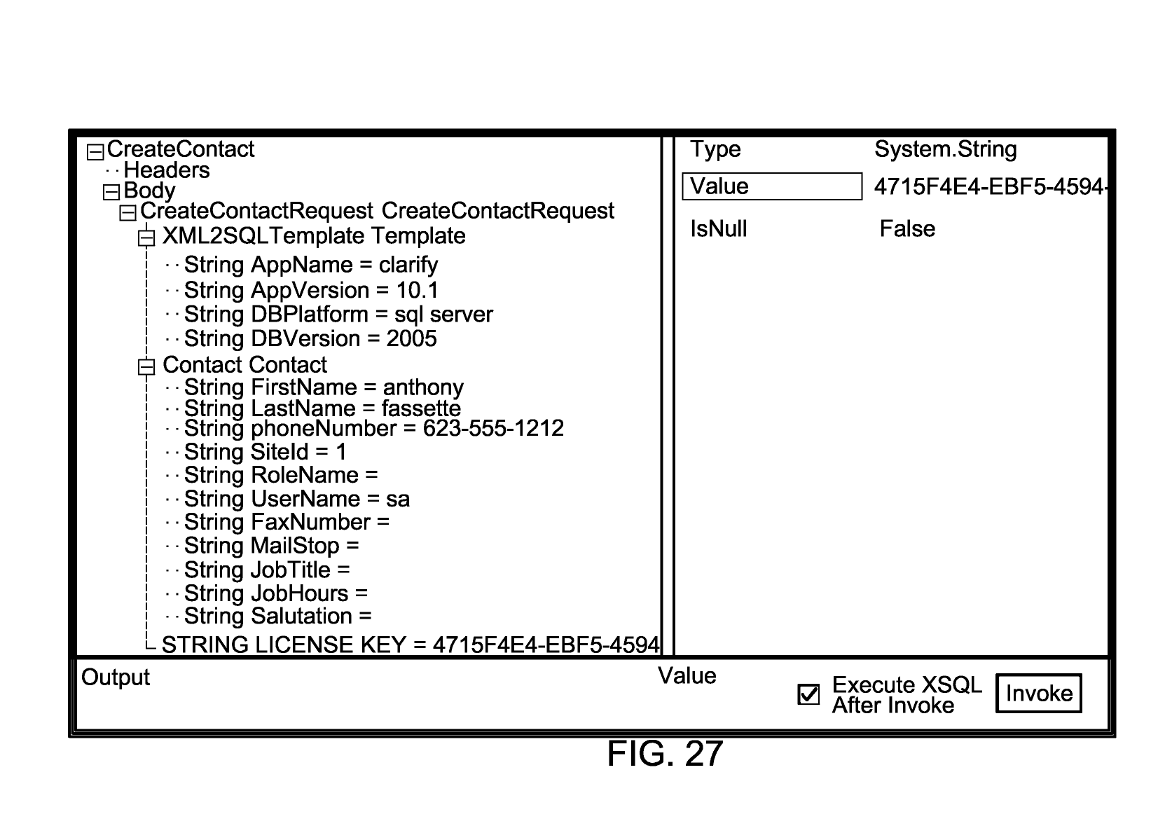

Preferably, in step Install API Processor 657, Subscriber 602 installs API Process 108 as a stored procedure with Application Content Database 219. Preferably, after installation of API Processor 108, Subscriber 602 preferably may request execution of any available API Template 304 against Application Content Database 219, as shown in step Request Execution of Desired API 660. Reference is made to FIG. 23 showing a system which preferably permits Subscriber 602 to select required API Template 304 and to FIG. 27 for input of data and requesting execution of required API Template 304.

Preferably, API Provider System Owner 902 responds by validating License Key 260 in step Validate License Key 661. If License Key 260 is valid, API Provider System Owner 902 preferably generates Encrypted API 306 preferably using pre-pended database commands, post-pended database commands and Environmental Parameters 261 from Subscriber 602.

Preferably, API Provider System Owner 902 then decrements usage credits belonging to Subscriber 602 based on usage-credit value of API Template 304 requested and the number of database operations requested, such as the number of updates requested. Preferably, the more complex database management functions consume more usage credits per usage than less complex database management functions, thus customers are only charged for the frequency of usages and the complexity of database management function used.

Some API Templates 304 do not require input data from Subscriber 602 to successfully execute against Application Content Database 219, for example, archiving inactive records where archival is based on a value in Application Content Database 219. Preferably, to prevent uncontrolled usage of certain API Templates 304, API Generator 106 will insert an expiration date into API Template 304 at the time it is generated and encrypted. Preferably, API Processor 108 will then evaluate the expiration date and either permit execution or notify Subscriber 602 that the current version of API Template 304 has expired and to request a fresh version API Template 304. Preferably, Usage Credit 268 will be decremented appropriately each time a new version of and expiring API Template 304 is requested.

Preferably, in step Decrypt and Execute Requested API 664, API Processor 108 receives requested Encrypted API 306, decrypts Encrypted API 306, executes it against Application Content Database 219 and sends Response Stream 402 to Subscriber 602.

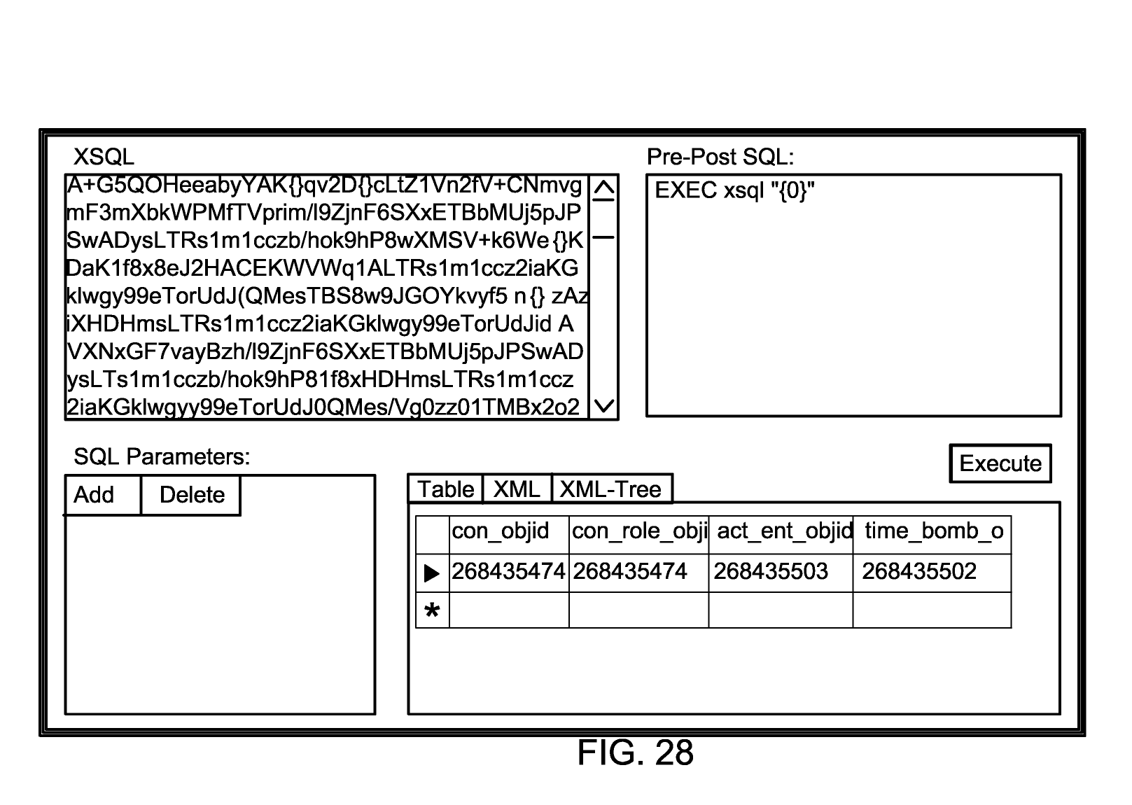

Preferably, in step Receive Execution Results 665, Subscriber 602 receives Response Stream 402 which presents the results of execution of requested API Template 304. Refer to FIG. 20, FIG. 21 and FIG. 28 for examples of sample results.

Upon reading the teachings of this specification, those with ordinary skill in the art will now understand that, under appropriate circumstances, considering issues such as competition, changes in technology, etc., other fee arrangements, such as, for example, annual fee for unlimited usage, a combination of fixed and variable usage fees, etc., may suffice.

Referring to FIG. 11, which shows a schematic diagram of Application Developer Licensing Business Method 700 associated with Database Management Function Provider Systems 100, according to a preferred embodiment of the present invention, API Provider System Owner 902 preferably completes Software Publisher License 705 with Consumer Software Publisher 701. Preferably, Software Publisher License 705 will permit Consumer Software Publisher 701 to utilize Database Management Function Provider Systems 100 to provide API Templates 304, created particularly for use with Consumer Application 708, to Consumer 703 who has licensed Consumer Application 708 from Consumer Software Publisher 701. Benefits to Consumer Software Publisher 701 may preferably include simplification of delivery of Consumer Application 708 and preferably creation of an ongoing revenue stream preferably based on usage of API Templates 304 by Consumer 703. Benefits to Consumer 703 may preferably include lower initial cost of Consumer Application 708, preferably access to many API Templates 304 not otherwise available, and preferably simplified operation of Consumer Application 708.

As shown, Consumer 703 preferably obtains Consumer Application License 712 from Consumer Software Publisher 701. Preferably, Consumer 703 implements Consumer Application 708 as Installed Consumer Application 710. At the time of implementation or subsequently, Consumer 703 may determine the need for API Templates 304 to accomplish one or more tasks not provided by Installed Consumer Application 710.

Preferably, Consumer Software Publisher 701 will offer access to API Templates 304 stored in API Templates Database 201 to Consumer 703 preferably in return for a subscription fee preferably based on usage of API Templates 304.

Preferably, completion of Consumer Application License 712 between Consumer Software Publisher 701 and Consumer 703 will permit access to API Templates 304 stored in API Templates Database 201. Preferably, Consumer 703 will then request API Templates 304 from API Templates Database 201 preferably in conjunction with use of Installed Consumer Application 710 and preferably receive results of execution of API Templates 304, collectively Task Request/Response 509. Preferably, usage will be as described with reference to FIG. 4, FIG. 5, FIG. 7 and FIG. 10.

Upon reading the teachings of this specification, those with ordinary skill in the art will now understand that, under appropriate circumstances, considering issues such as competition, changes in technology, changes in market conditions for software, etc., other licensing arrangements, such as, for example, licensing directly with commercial application providers, licensing directly with database management system providers, etc., may suffice.

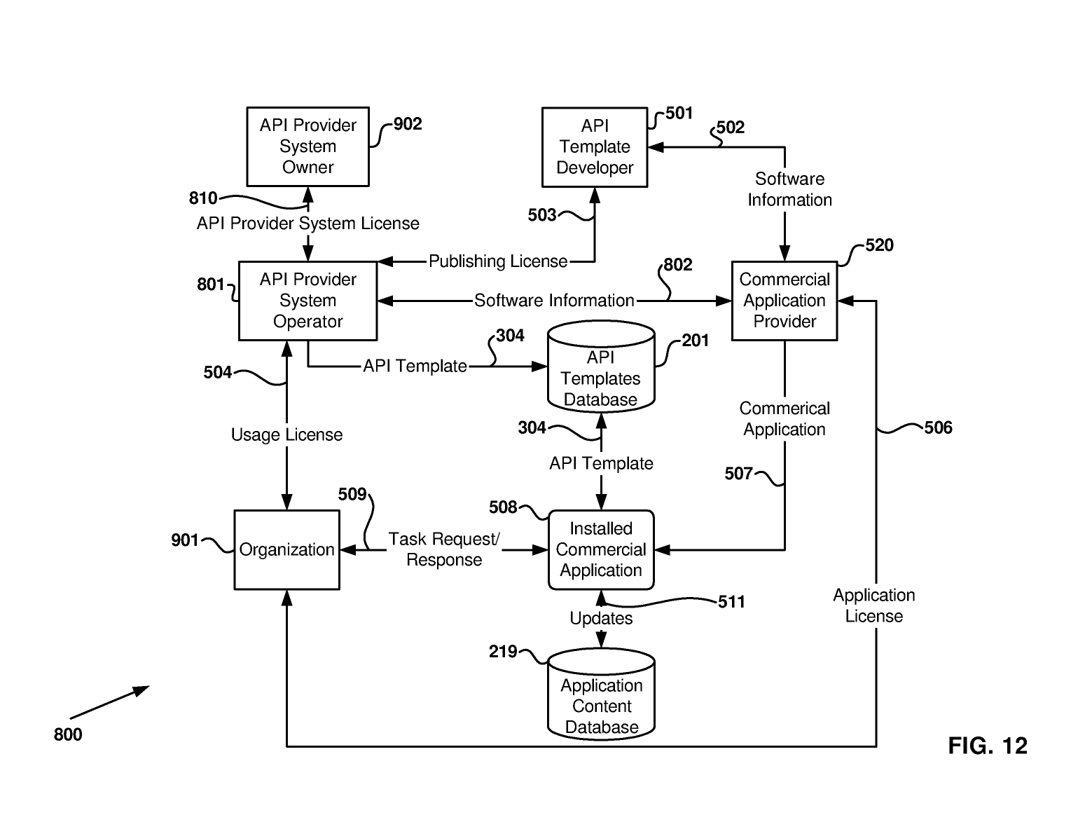

Referring to FIG. 12, which shows a schematic diagram of Operations Licensing Business Method 800 associated with Database Management Function Provider Systems 100, according to a preferred embodiment of the present invention, API Provider System Owner 902 preferably completes API Provider System License 810 with API Provider System Operator 801. Preferably, API Provider System License 810 permits API Provider System Operator 801 to utilize Database Management Function Provider Systems 100 preferably to offer API Templates 304 to Organization 901. In return, API Provider System Operator 801 will preferably pay API Provider System Owner 902 a mutually agreed license fee.

API Provider System Operator 801 preferably obtains Software Information 502 from Commercial Application Provider 520 (representative of a variety of software providers including companies such as JD Edwards, PeopleSoft, Seibel and others) regarding methods of database and application operation and design for the purpose of creating API Template 304 (representing any number of diverse and useful database management functions) for creating and maintaining API Templates Database 201. Additionally, API Provider System Operator 801 may preferably complete Publishing License 503 with one or more API Template Developers 501 preferably for the purpose of securing additional API Templates 304 for inclusion in API Templates Database 201. Preferably, Publishing License 503 will permit API Provider System Operator 801 to make API Templates 304 available to Organization 901 and, in return, API Provider System Operator 801 will preferably pay API Template Developer 501 a royalty fee.

As shown, Organization 901 preferably obtains an Application License 506 from Commercial Application Provider 520 which in turn preferably provides Commercial Application 507 to Organization 901. Preferably, Organization 901 implements Commercial Application 507 as Installed Commercial Application 508. At the time of implementation or subsequently, Organization 901 may preferably determine the need for API Templates 304 to accomplish one or more tasks not provided by Installed Commercial Application 508.

Preferably, API Provider System Operator 801 will offer access to API Templates 304 stored in API Templates Database 201 to Organization 901 and its members preferably in return for a subscription fee based on usage of API Templates 304. (Refer to discussion with reference to FIG. 10 for preferred subscription methods.)

Preferably, completion of Usage License 504 between API Provider System Operator 801 and Organization 901 will permit access to API Templates 304 stored in API Templates Database 201. Preferably, members of Organization 901 will then request API Templates 304 from API Templates Database 201 in conjunction with use of Installed Commercial Application 508 and preferably receive results of execution of API Templates 304, collectively Task Request/Response 509. Preferably, usage will be as described with reference to FIG. 4, FIG. 5, FIG. 7 and FIG. 10. Preferably, results of execution of API Templates 304 may result in Updates 511 being made to Application Content Database 219.

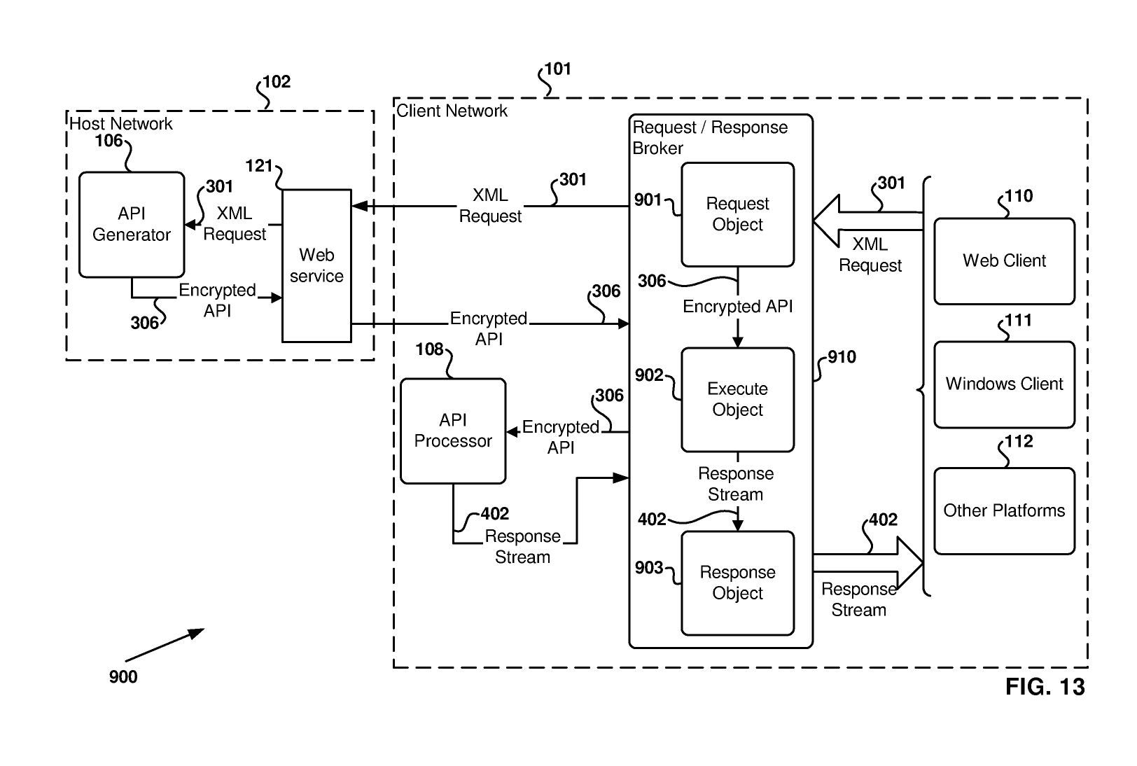

Referring to FIG. 13, which shows a schematic diagram of use of Request/Response Broker Process 900 to manage communications between client network and host network for Database Management Function Provider Systems 100 where access outside of client network is restricted, according to a preferred embodiment of the present invention, preferably all communications are managed through a single point-Request/Response Broker 910. Preferably, Web Client 110, Windows Client 111 or Other Platforms Client 112 prepares and sends XML Request 301, including data, to Request/Response Broker 910.

Preferably, Request Object 901 receives XML Request 301, establishes a connection to Web Service 121, and forwards XML Request 301 to Web Service 121. Preferably, Web Service 121, operating as described with reference to FIG. 5, sends XML Request 301 and Encryption Key 309 for Subscriber 602 to API Generator 106. Preferably, API Generator 106, operating as described with reference to FIG. 5, produces Encrypted API 306 with data and preferably sends Encrypted API 306 to Web Service 121. Preferably, Web Service 121 then forwards Encrypted API 306 to the Request Object 901. Preferably, Request Object 901, in turn, forwards Encrypted API 306 with data to Execute Object 902 of the Request/Response Broker 910.

Preferably, Execute Object 903 calls API Processor 108 and passes Encrypted API 306 with data API Processor 108. Preferably, API Processor 108, operating as described with reference to FIG. 7, decrypts and preferably executes Encrypted API 306 and preferably produces Response Stream 402, which is then preferably sent to Execute Object 902. Preferably, then Execute Object 902 passes Response Stream 402 to Response Object 903 of Request/Response Broker 910. Preferably, Response Object 903 sends the Response Stream 402 to Web Client 110, Windows Client 111 or Other Platforms Client 112. Preferably, Request/Response Broker 910 operates to manage all communications between API Generator 106 and Web Client 110, Windows Client 111 or Other Platforms Client 112, and between API Processor 108 and Web Client 110, Windows Client 111 or Other Platforms Client 112, thus reducing communication between Host Network 102 and Client Network 101 to a single point, improving control and security especially for Client Network 101.

Although applicant has described applicant's preferred embodiments of this invention, it will be understood that the broadest scope of this invention includes modifications such as diverse shapes, sizes, and materials. Such scope is limited only by the below claims as read in connection with the above specification.

Further, many other advantages of applicant's invention will be apparent to those skilled in the art from the above descriptions and the below claims.

What is claimed is:

1) A network-based method relating to providing at least one database management function, by at least one host database-management-functions provider, to at least one client user of at least one client content database, comprising the steps of:
a) securing, by such at least one host database-management-functions provider, of at least one program-code module structured and arranged to interact with such at least one client content database;
b) receiving, by such at least one host database-management-functions provider, of at least one request, from such at least one client user, relating to execution of such at least one database management function relating to such at least one client content database;
c) computer-generating, by such at least one host database-management-functions provider, of such requested at least one database management function from such at least one program-code module;
d) transmitting, by such at least one host database-management-functions provider, such requested at least one database management function to such at least one client user; and
e) empowering, by such at least one host database-management-functions provider, of such at least one client user, to computer-execute such at least one transmitted database management function.

2) The network-based method according to claim 1 further comprising the steps of:
a) assigning, by such at least one host database-management-functions provider, at least one unique encryption key to such at least one client user; and
b) encrypting, by such at least one host database-management-functions provider, of such at least one computer-generated database management function, using such assigned at least one encryption key.

3) The network-based method according to claim 2 wherein such step of empowering, by such at least one host database-management-functions provider, of such at least one client user, to computer-execute such at least one transmitted database management function comprises the steps of:
a) transmitting, by such at least one host database-management-functions provider, of at least one function processor to such at least one client user;
b) wherein such at least one function processor comprises such assigned at least one encryption key; and
c) wherein such at least one function processor is structured and arranged to hide such assigned at least one encryption key from such at least one client user; and
d) enabling decrypting, by such transmitted at least one function processor, of such encrypted at least one database management function, using such assigned at least one encryption key;
e) enabling computer-executing, using such transmitted at least one function processor, of such decrypted at least one database management function on behalf of such at least one client user; and
f) enabling presenting of at least one result of such computer-execution of such transmitted database management function to such at least one client user.

4) The network-based method according to claim 3 further comprising the steps of:
a) receiving, by such at least one host database-management-functions provider, of client data relating to such requested database management function and relating to such at least one client content database, from such at least one client user; and
b) computer-generating, by such at least one host database-management-functions provider, of at least one database management function;
c) wherein such computer-generated at least one database management function comprises such received client data; and
d) wherein such computer-generated at least one database management function comprises such requested at least one database management program-code module.

5) The network-based method according to claim 4 further comprising the steps of:
a) offering, by such at least one host database-management-functions provider, authorization to request computer execution of such at least one database management function, to such at least one client user;
b) receiving, by such at least one host database-management-functions provider, at least one minimum payment for at least one predicted number of such requests for such computer executions on behalf of such at least one client user; and
c) performing such authorizing by such at least one host database-management-functions provider.

6) The network-based method according to claim 1 further comprising the steps of:
a) offering, by such at least one host database-management-functions provider, authorization to request computer execution of such at least one database management function, to such at least one client user;
b) receiving, by such at least one host database-management-functions provider, at least one minimum payment for at least one predicted number of such requests for such computer executions on behalf of such at least one client user; and
c) performing such authorizing by such at least one host database-management-functions provider.

7) The network-based method according to claim 6 further comprising the steps of:
a) estimating, by such at least one client user, of at least one first count of requests for computer-execution of such at least one database management function for at least one time period;
b) associating, by such at least one host database-management-functions provider, of at least one monetary value with computer-execution of such at least one database management function;
c) calculating, by such at least one host database-management-functions provider, of such at least one minimum payment comprising at least one amount from multiplying of such at least one first count multiplied by such monetary value;
d) accumulating, by such at least one host database-management-functions provider, at least one second count of actual requests for computer-execution of such at least one database management function for such at least one time period;
e) calculating, by such at least one host database-management-functions provider, cost of computer-execution of such at least one database management function by multiplying such at least one second count by such monetary value;
f) receiving, by such at least one host database-management-functions provider, at least one overage payment from such at least one client user when such cost exceeds such at least one amount from multiplying of such at least one first count multiplied by such monetary value for such at least one time period.

8) The network-based method according to claim 4 further comprising the step of licensing, by such at least one host database-management-functions provider, operations of such database-management-functions provider to at least one licensee.

9) The network-based method according to claim 4 further comprising the step of permitting, by such at least one host database-management-functions provider, providing at least one database command by such at least one client user to be included for determined sequential computer-execution within such computer-generated at least one database management function.

10) The network-based method according to claim 4 wherein such step of computer-generating, by such at least one host database-management-functions provider, of such requested at least one database management function from such at least one program-code module is completed within at least one host network, controlled by such at least one host database-management-functions provider.

11) The network-based method according to claim 10 wherein such step of computer-executing, using such transmitted at least one function processor, such decrypted at least one database management function on behalf of such at least one client user is completed within at least one client network, controlled by such at least one client user.

12) The network-based method according to claim 11 further comprising the steps of:
a) providing, by such at least one host database-management-functions provider at least one inter-network communications manager tool to such at least one client user; and
b) managing, by such at least one inter-network communications manager tool, inter-network communications between such at least one client network and such at least one host network on behalf of such at least one client user;
c) wherein such inter-network communications relate to such step of computer-generating, by such at least one host database-management-functions provider, of such requested at least one database management function from such at least one program-code module; and
d) wherein such inter-network communications relate to such step of computer-executing, using such transmitted at least one function processor, such decrypted at least one database management function on behalf of such at least one client user.

13) The network-based method according to claim 3 further comprising the step of storing such at least one function processor within such at least one client content database as at least one stored procedure.

14) The network-based method according to claim 1 further comprising the steps of:
a) associating, by such at least one host database-management-functions provider, at least one date of expiration with such computer-generated at least one database management function; and
b) preventing, by such at least one host database-management-functions provider, computer-execution of such at least one database management function when current date is greater than such associated at least one expiration date.

15) A network-based computer system, relating to providing at least one database management function to at least one client user of at least one client content database, comprising:
a) at least one first computer interface for inputting at least one program-code module structured and arranged to interact with such at least one client content database;
b) at least one first computer database storage for storing of such at least one program-code module in at least one host program-code module database;
c) at least one second computer interface structured and arranged to receive at least one request, by such at least one client user, relating to execution of such at least one database management function relating to such at least one client content database;
d) at least one first computer processor structured and arranged to generate such requested at least one database management function from such stored at least one program-code module;
e) at least one first computer transmitter for transmitting such requested at least one database management function to such at least one client user; and
f) at least one second computer processor structured and arranged to control execution of such at least one transmitted database management function against such at least one client content database.

16) The network-based computer system, according to claim 15 further comprising:
a) at least one third computer processor structured and arranged to assign at least one unique encryption key to such at least one client user; and
b) at least one fourth computer processor structured and arranged to encrypt such at least one computer-generated database management function, using such assigned at least one encryption key.

17) The network-based computer system, according to claim 16 further comprising:
a) at least one fifth computer processor structured and arranged to generate such at least one second computer program;
b) wherein such generated at least one second computer program comprises such assigned at least one encryption key; and
c) wherein such generated at least one second computer program is structured and arranged to hide such assigned at least one encryption key from such at least one client user; and
d) at least one second computer transmitter structured and arranged to transmit such generated at least one second computer program to such at least one client user;
e) wherein such generated at least one second computer processor is further structured and arranged to decrypt such encrypted at least one database management function, using such assigned at least one encryption key;
f) wherein such generated at least one second computer processor is further structured and arranged to execute such decrypted at least one database management function against such at least one client content database on behalf of such at least one client user; and
g) at least one third computer interface structured and arranged to display at least one result of such computer-execution of such generated database management function to such at least one client user.

18) The network-based computer system, according to claim 17 further comprising:
a) at least one fourth computer interface structured and arranged to receive client data relating to such requested database management function and relating to such at least one client content database, from such at least one client user;
b) wherein such at least one first computer processor is further structured and arranged to generate at least one database management function from such received client data and such requested at least one database management program-code module.

19) The network-based computer system, according to claim 18 further:
a) at least one fifth computer interface structured and arranged to offer authorization to request computer execution of such at least one database management function, to such at least one client user;
b) at least one sixth computer interface structured and arranged to record at least one minimum payment amount on behalf of such at least one client user; and
c) at least one second computer database storage structured and arranged to store such recorded at least one minimum payment in at least one payments database;
d) at least one sixth computer processor structured and arranged to authorize requesting computer-execution of such at least one database management function by such at least one client user.

20) The network-based computer system, according to claim 19 further comprising:
a) at least one seventh computer interface structured and arranged to record at least one estimated count of requests for computer-execution of such at least one database management function, for at least one time period, on behalf of such at least one client user;
b) at least one eighth computer interface structured and arranged to receive at least one monetary value related to execution of such at least one database management function;
c) at least one third computer database storage structured and arranged to store such received at least one monetary value related to execution of such at least one database management function in at least one monetary value database;
d) at least one seventh computer processor structured and arranged to calculate such at least one minimum payment comprising at least one amount from multiplying of such at least one estimated count multiplied by such monetary value;
e) at least one eighth computer processor structured and arranged to accumulate at least one actual count of actual requests for execution of such at least one database management function for such at least one time period;
f) at least one ninth computer processor structured and arranged to calculate cost of execution of such at least one database management function by multiplying such at least one actual count by such monetary value;
g) at least one tenth computer processor structured and arranged to notify such at least one client user such calculated cost of execution exceeds such at least one minimum payment for such at least one time period; and
h) at least one tenth computer interface structured and arranged to record at least one overage payment from such at least one client user.

21) The network-based computer system, according to claim 18 further comprising:
a) at least one eleventh computer interface structured and arranged to permit inputting of at least one database command to be included for determined sequential computer-execution within such generated at least one database management function, on behalf of such at least one client user; and
b) at least one first computer processor further structured and arranged to consolidate such at least one database command with such generated at least one database management function.

22) The network-based computer system, according to claim 18 wherein such at least one first computer processor operates within at least one host network.

23) The network-based computer system, according to claim 22 wherein such at least one second computer processor operates within at least one client network.

24) The network-based computer system, according to claim 23 further comprises:
a) at least one twelfth computer processor structured and arranged to manage inter-network communication between such at least one client network and such at least one host network on behalf of such at least one client user;
b) wherein such inter-network communications relate to such at least one first computer processor; and
c) wherein such inter-network communications relate to such at least one second computer processor.

25) The network-based computer system, according to claim 17 comprises:
a) at least one fourth computer storage structured and arranged to store, as at least one stored procedure, such at least one second computer processor within such at least client content database.

26) The network-based computer system, according to claim 15 further comprises:
a) such at least one first computer processor further structured and arranged to generate such requested at least one database management function with at least one date of expiration; and
b) such at least one second computer process further structured and arranged to preventing execution of such requested at least one database management function when current date is greater than such at least one expiration date of such requested at least one database management function.

27) A network-based computer program system, relating to providing at least one database management function to at least one client user, comprising the steps of:
a) permitting inputting at least one program-code module structured and arranged to interact with such at least one client content database;
b) storing of such at least one program-code module structured and arranged to interact in at least one host program-code module database;
c) permitting inputting of at least one request, on behalf of such at least one client user, relating to execution of such at least one database management function relating to such at least one client content database;
d) executing at least one function generator to generate such requested at least one database management function from such stored at least one program-code module;
e) transmitting such requested at least one database management function to such at least one client user; and
f) controlling, on behalf of such at least one client user, execution of such at least one transmitted database management function against such at least one client content database.

28) The network-based computer program system according to claim 27 further comprising the steps of:
a) assigning at least one unique encryption key to such at least one client user; and
b) encrypting such at least one generated database management function, using such assigned at least one encryption key.

29) The network-based computer program system according to claim 28 wherein such step of controlling, on behalf of such at least one client user, execution of such at least one transmitted database management function against such at least one client content database comprises the steps of:
a) generating at least one function processor on behalf of such at least one client user;
b) wherein such generated at least one function processor comprises such assigned at least one encryption key;
c) wherein such generated at least one function processor is structured and arranged to hide such assigned at least one encryption key from such at least one client user; and
d) transmitting, such at least one function processor to such at least one client user;
e) executing such generated at least one function processor to decrypt such encrypted at least one database management function, using such assigned at least one encryption key;
f) executing such at least one function processor to complete execution of such decrypted at least one database management function on behalf of such at least one client user; and
g) displaying at least one result of such computer-execution of such transmitted database management function to such at least one client user.

30) The network-based computer program system according to claim 29 further comprising the steps of:
a) permitting inputting of client data relating to such requested database management function and relating to such at least one client content database, by such at least one client user; and
b) executing such at least one function generator to generate at least one database management function;
c) wherein such generated at least one database management function comprises such inputted client data; and
d) wherein such generated at least one database management function comprises such at least one database management program-code module.

31) The network-based computer program system according to claim 30 further comprising the steps of:
a) permitting inputting of recording at least one minimum payment amount for authorization to request execution of such at least one database management function on behalf of such at least one client user;
b) storing such inputted at least one minimum payment amount in at least one client payments database; and
c) authorizing requesting execution of such at least one database management function by such at least one client user.

32) The network-based computer program system according to claim 31 wherein such step of permitting inputting of at least one minimum payment amount for authorization to request execution of such at least one database management function on behalf of such at least one client user comprises the steps of:
a) permitting inputting, on behalf of such at least one client user of at least one estimated count of requests for execution of such at least one database management function for at least one time period;
b) permitting inputting at least one monetary value associated with execution of such at least one database management function;
c) storing such inputted at least one monetary value in at least one monetary values database;
d) calculating such at least one minimum payment comprising at least one amount from multiplying such at least one estimated count by such at least one monetary value;
e) accumulating at least one actual count of inputted requests for computer-execution of such at least one database management function for such at least one time period;
f) calculating at least one cost of executing such at least one database management function by multiplying such at least one actual count by such monetary value for such at least one database management function;
g) notifying such at least one client user of at least one overage payment amount due when such calculated at least one cost exceeds such received at least one minimum payment amount;
h) permitting inputting of receipt of such at least one overage payment amount; and
i) storing such received at least one overage payment amount in such at least one client payments database.

33) The network-based computer program system according to claim 30 further comprising the steps of;
a) permitting inputting, by such at least one client user, of at least one database command to be included for determined sequential execution within such generated at least one database management function; and
b) executing such at least one function processor to execute such at least one database command in such determined sequential execution with such generated at least one database management function.

34) The network-based computer program system according to claim 30 wherein such step of executing at least one function generator to generate such requested at least one database management function from such stored at least one program-code module is completed within at least one host network controlled by such at least one network-based computer program system operator.

35) The network-based computer program system according to claim 28 wherein such step of executing such at least one function processor to complete execution of such decrypted at least one database management function on behalf of such at least one client user is completed within at least one client network controlled by such at least one client user.

36) The network-based computer program system according to claim 35 further comprising the steps of:
a) executing at least one inter-network communications manager to manage inter-network communications between such at least one client network and such at least one host network on behalf of such at least one client user; and
b) wherein such inter-network communications relate to execution of such at least one function processor;
c) wherein such inter-network communications relate to execution of such at least one function generator.

37) The network-based computer program system according to claim 29 further comprising the step of storing such at least one function processor within such at least client content database as at least one stored procedure.

38) The network-based computer program system according to claim 27 further comprising the steps of:
a) executing such at least one function generator to generate such at least one database management function with at least one date of expiration; and
b) executing such at least one function generator to prevent execution of such at least one database management function when current date is greater than such associated at least one expiration date.
